(19) United States
(12) Patent Application Publication
(10) Pub. No.: US 2025/0393017 A1
(43) Pub. Date: Dec. 25, 2025

(54) METHOD FOR MAXIMUM LIKELIHOOD POSITION ESTIMATION

(71) Applicant: ZaiNar, Inc., Redwood City, CA (US)

(72) Inventors: Babak Azimi-Sadjadi, Redwood City, CA (US); Philip A. Kratz, Redwood City, CA (US); Siamak Yousefi, Redwood City, CA (US)

(21) Appl. No.: 19/249,114

(22) Filed: Jun. 25, 2025

Related U.S. Application Data
(60) Provisional application No. 63/663,879, filed on Jun. 25, 2024.

(51) Int. Cl. H04W 64/00

(52) U.S. Cl. CPC H04W 64/00

(57) ABSTRACT

A method includes: calculating a first probability distribution representing a first set of probability masses for the device occupying positions of a reference coordinate system based on a first set of time-of-arrival estimates, for a signal transmitted from a device and received at a first node, and a first position occupied by the first node; calculating a second probability distribution representing a second set of probability masses for the device occupying the positions based on a second set of time-of-arrival estimates, for the signal received at a second node, and a second position occupied by the second node; calculating a joint probability distribution for the positions based on a product of the first set of probability masses and the second set of probability masses; and calculating an estimated position occupied by the device, the estimated position characterized by the greatest probability mass in the joint probability distribution.

### CROSS-REFERENCE TO RELATED APPLICATIONS

This application claims the benefit of U.S. Provisional Application No. 63/663,879, filed on 25 Jun. 2024, which is incorporated in its entirety by this reference.

### TECHNICAL FIELD

This invention relates generally to the field of network-based positioning and, more specifically, to a new and useful method for maximum likelihood position estimation within the field of network-based positioning.

### BRIEF DESCRIPTION OF THE FIGURES

FIGS. 1A and 1B are flowchart representations of a method;

FIG. 2 is a flowchart representation of one variation of the method;

FIG. 3 is a flowchart representation of one variation of the method;

FIG. 4 is a flowchart representation of one variation of the method; and

FIG. 5 is a flowchart representation of one variation of the method.

### DESCRIPTION OF THE EMBODIMENTS

The following description of embodiments of the invention is not intended to limit the invention to these embodiments but rather to enable a person skilled in the art to make and use this invention. Variations, configurations, implementations, example implementations, and examples described herein are optional and are not exclusive to the variations, configurations, implementations, example implementations, and examples they describe. The invention described herein can include any and all permutations of these variations, configurations, implementations, example implementations, and examples.

### 1. METHODS

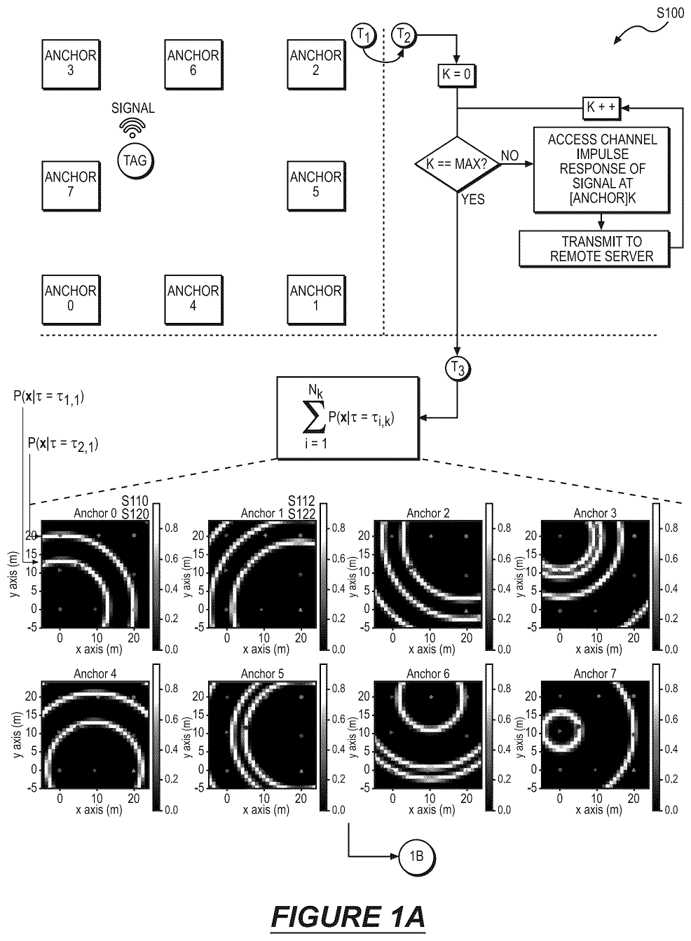

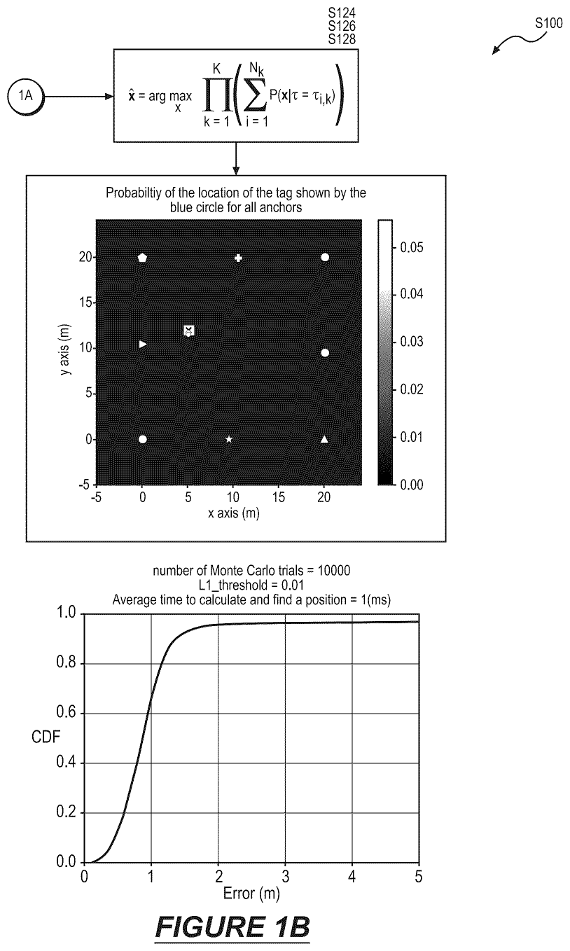

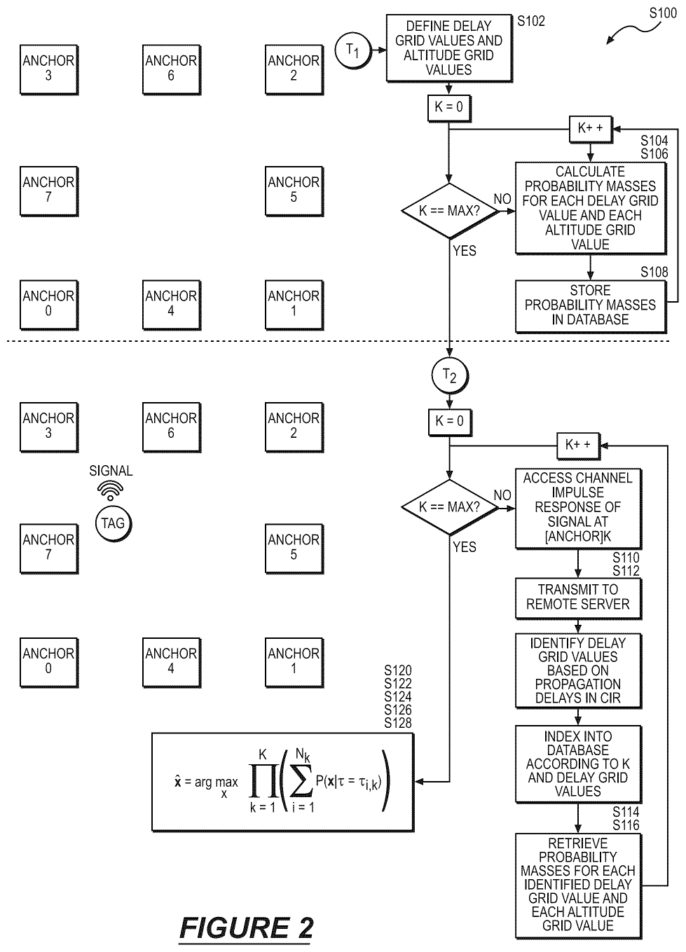

As shown in FIGS. 1A, 1B, and 2, a method S100 includes: accessing a first set of propagation delay values of a first channel impulse response for a localization signal transmitted from a target device and received at a first node in a set of nodes in Block S110; accessing a second set of propagation delay values of a second channel impulse response for the localization signal received at a second node in the set of nodes in Block S112; generating a first probability map in a set of probability maps in Block S120, the first probability map representing a first set of conditional probability masses for a set of positions in a reference coordinate system; and generating a second probability map in the set of probability maps in Block S122, the second probability map representing a second set of conditional probability masses for the set of positions. Each conditional probability mass, in the first set of conditional probability masses, represents a probability mass for the target device occupying a position in the set of positions based on the first set of propagation delay values. Each conditional probability mass, in the second set of conditional probability masses, represents a probability mass for the target device occupying a position in the set of positions based on the second set of propagation delay values.

The method S100 also includes: generating a composite probability map based on the set of probability maps in Block S126; and calculating an estimated position, in the set of positions, occupied by the target device based on the composite probability map in Block S128. The composite probability map represents a third set of conditional probability masses for the set of positions based on a product of the first set of conditional probability masses and the second set of conditional probability masses. The estimated position is characterized by a greatest probability mass in the third set of conditional probability masses.

### 1.1 Variation: Multi-Phase Maximum Likelihood Position Estimation

As shown in FIGS. 1A, 1B, and 2, one variation of the method S100 includes, during a first time period: defining a set of delay grid values in Block S102, each delay grid value in the set of delay grid values corresponding to a candidate propagation delay of a candidate signal transmitted from a candidate device and received at a node in a set of nodes; calculating a first subset of conditional probability masses for a first node in the set of nodes in Block S104; and calculating a second subset of conditional probability masses for a second node in the set of nodes in Block S106. Each conditional probability mass in the first subset of conditional probability masses represents a probability mass for the candidate device occupying a position in a set of positions of a reference coordinate system based on: a first delay grid value in the set of delay grid values; and a first position, in the reference coordinate system, occupied by the first node. Each conditional probability mass in the second subset of conditional probability masses represents a probability mass for the candidate device occupying a position in the set of positions based on: a second delay grid value in the set of delay grid values; and a second position, in the reference coordinate system, occupied by the second node.

This variation of the method S100 also includes, during a second time period succeeding the first time period: accessing a first set of propagation delay values for a localization signal transmitted from a target device received at the first node in Block S110; accessing a second set of propagation delay values for the localization signal received at the second node in Block S112; accessing the first subset of conditional probability masses in response to detecting correspondence between a first propagation delay value, in the first set of propagation delay values, and the first delay grid value in Block S114; accessing the second subset of conditional probability masses in response to detecting correspondence between a second propagation delay value in the second set of propagation delay values and the second delay grid value in Block S116; calculating a composite set of conditional probability masses based on a product of the first subset of conditional probability masses and the second subset of conditional probability masses in Block S124; and calculating an estimated position, in the set of positions, occupied by the target device in Block S128. Each conditional probability mass, in the set of conditional probability masses, represents a probability mass for the target device occupying a position in the set of positions based on the first set of propagation delay values and the second set of propagation delay values. The estimated position is characterized by a greatest probability mass in the composite set of conditional probability masses.

### 1.2 Variation: Time-of-Arrival Maximum Likelihood Position Estimation

As shown in FIGS. 1A, 1B, and 2, one variation of the method S100 includes: accessing a first set of time-of-arrival estimates for a localization signal transmitted from a target device and received at a first node in Block S110; accessing a second set of time-of-arrival estimates for the localization signal received at a second node in Block S112; calculating a first set of conditional probability masses for a set of positions of a reference coordinate system in Block S120; and calculating a second set of conditional probability masses for the set of positions in Block S122. Each conditional probability mass in the first set of conditional probability masses represents a probability mass for the target device occupying a position in the set of positions based on: the first set of time-of-arrival estimates; and a first position, in the set of positions, occupied by the first node. Each conditional probability mass in the second set of conditional probability masses represents a probability mass for the target device occupying a position in the set of positions based on: the second set of time-of-arrival estimates; and a second position, in the set of positions, occupied by the second node.

This variation of the method S100 also includes: calculating a composite set of conditional probability masses for the set of positions based on a product of the first set of conditional probability masses and the second set of conditional probability masses in Block S124; and calculating an estimated position, in the set of positions, occupied by the target device based on the composite set of conditional probability masses in Block S128, the estimated position characterized by a greatest probability mass in the composite set of conditional probability masses.

### 2. APPLICATIONS

Generally, a system—including or interfacing with a target device (e.g., a transmitter, an active tag, a mobile phone), a set of nodes (e.g., receivers, anchors, 5G gNodeBs), and/or a remote computer system (e.g., a remote server)—can execute Blocks of the method S100: to transmit a signal (e.g., a localization signal) from the target device; to receive the signal at each node; to calculate a channel impulse response-characterized by propagation delay values for components (e.g., a line-of-sight component, multipath components) of the signal—for the signal received at each node; to generate a probability map for each node and representing a probability distribution for the target device occupying positions, in a reference coordinate system representing a space in which the target device and nodes are deployed, based on these propagation delay values; and to calculate an estimated position (e.g., a maximum likelihood position), in the reference coordinate system, occupied by the target device based on a combination of the probability maps (e.g., a joint probability distribution).

Therefore, the system can execute Blocks of the method S100: to designate each propagation delay value as a candidate propagation delay value for a line-of-sight component of the signal; to calculate subsets of conditional probability masses (or probability densities) for the target device occupying positions within the reference coordinate system based on the propagation delay values; to generate a set of probability maps representing these subsets of conditional probability masses for the set of nodes; to combine conditional probability masses represented in a combination of the set of probability maps; and to derive the estimated position-characterized by the greatest probability mass in the combination of the set of probability maps (e.g., in the joint probability distribution)—occupied by the target device within the reference coordinate system, thereby improving accuracy of position estimation when propagation delay values for line-of-sight components of the signal are unknown (or uncertain).

For example, the system can execute Blocks of the method S100: to access a first channel impulse response for the signal received at a first node and characterized by a first propagation delay value (e.g., 100 nanoseconds); and to calculate a first subset of conditional probability masses (e.g., a first concentric circle (or ellipse)—around a first known position of the first node in the reference coordinate system—characterized by non-zero probability mass values) for the target device occupying positions in the reference coordinate system based on the first propagation delay value and the first known position of the first node.

In this example, the system can execute Blocks of the method S100: to calculate subsets of conditional probability masses for the target device occupying positions in the reference coordinate system based on each propagation delay value in the first channel impulse response; and to aggregate these subsets of conditional probability masses into a first probability map (or a first probability distribution) characterized by multiple concentric circles—around the first known position of the first node—characterized by non-zero probability values. The system can execute Blocks of the method S100: to generate a probability map (or a probability distribution) for each node based on a channel impulse response of the signal at the node; and to calculate the estimated position, in the reference coordinate system, occupied by the target device based on these probability maps (e.g., a joint probability distribution based on these probability distributions).

Therefore, by calculating the estimated position characterized by the greatest probability mass in the combination of these probability maps (or the joint probability distribution), the system can execute Blocks of the method S100 to identify the estimated position associated with subsets of conditional probability masses attributed to line-of-sight components-which are characterized by greater probability than subsets of conditional probability masses attributed to multipath components—of the signal received at the nodes.

### 2.1 Multi-Phase Maximum Likelihood Position Estimation

Additionally, the system can execute Blocks of the method S100: to define a set of delay grid values (e.g., grid values characterized by an increment of one nanosecond) corresponding to possible propagation delay values; to define a set of altitude grid values (e.g., grid values characterized by an increment of one meter) for the reference coordinate system and corresponding to altitudes of an area of interest in the space; and to pre-compute a corpus of conditional probability masses (or probability distributions)—for each possible combination of delay grid value and altitude grid value—for each node during an offline processing phase.

Then, during a subsequent online processing phase, the system can execute Blocks of the method S100: to estimate channel impulse responses for the signal transmitted from the target device and the nodes; to selectively retrieve these conditional probability masses from a corpus of probability masses according to these channel impulse responses; and to assemble selected conditional probability masses into a joint probability distribution in order to reduce response time to calculate the estimated position occupied by the target device based on these conditional probability masses.

Therefore, the system can execute Blocks of the method S100: to access a channel impulse response associated with a node and characterized by a set of propagation delay values; to index a corpus of conditional probability masses for the node based on the set of propagation delay values to a compile pre-computed subsets of conditional probability masses associated with the set of propagation delay values; and to generate a probability map representing a probability distribution based on these subsets of conditional probability masses, thereby enabling the system to calculate the estimated position occupied by the target device based on a combination of probability maps for the set of nodes while reducing computational costs and/or reducing response time.

Advantageously, the system can execute Blocks of the method S100 to enable non-line-of-sight (or “NLOS”) detection as part of the positioning process. Since the algorithm is computationally efficient—using precomputed probability maps retrieved from a database, with no need for runtime simulation or ray-tracing—the system can execute Blocks of the method S100 to apply a combinatorial strategy: subsets of available measurements (from different nodes) are selected, and the conditional probability (or probability mass) of position is recomputed using only those subsets. By comparing the resulting probabilities (or probability masses), the system can detect when inclusion of certain measurements (typically from non-line-of-sight paths) degrades the positioning likelihood. In this way, the system can execute Blocks of the method S100 to perform implicit non-line-of-sight detection, improving positioning accuracy in environments with multipath and blocked line-of-sight (or “LOS”).

### 2.2 Variation: Time Difference of Arrival Maximum Likelihood Positioning

As described herein, the system executes Blocks of the method S100: to generate a probability map representing a probability distribution for the target device occupying positions in a reference coordinate system based on a set of propagation delay values (e.g., times of arrival) in a channel impulse response for each node; and to estimate a target position of the transmitter within the three-dimensional space based on a combination of the probability maps representing a joint probability distribution for the set of nodes.

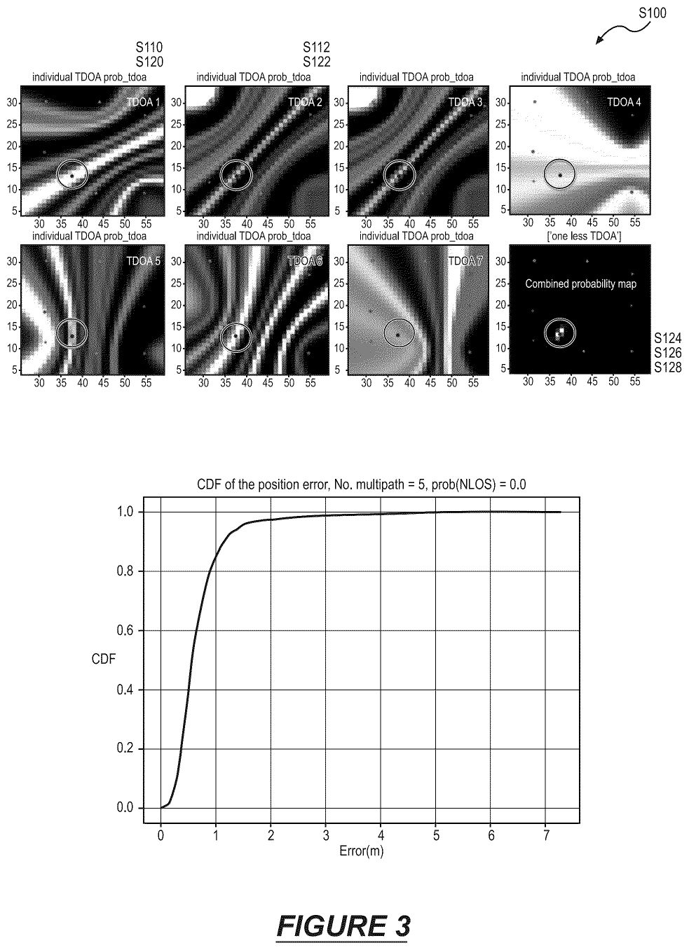

However, as shown in FIG. 3, the system can similarly execute Blocks of the method S100: to generate a probability map representing a probability distribution for a target device occupying positions within a three-dimensional space based on differences between propagation delay values (e.g., time differences of arrival) of channel impulse responses for each pair of nodes; and to estimate a target position of the transmitter within the three-dimensional space based on a combination of the probability maps for the set of nodes.

### 2.3 Variation: Probability Density

As described herein, the system executes Blocks of the method S100: to calculate subsets of conditional probability masses for the target device occupying positions within the reference coordinate system based on propagation delay values; to generate a set of probability maps representing these subsets of conditional probability masses for the set of nodes; to combine conditional probability masses represented in a combination of the set of probability maps; and to derive the estimated position-characterized by the greatest probability mass in the combination of the set of probability maps-occupied by the target device within the reference coordinate system.

However, as shown in FIG. 3, the system can similarly execute Blocks of the method S100: to calculate subsets of conditional probability densities for the target device occupying positions within the reference coordinate system based on propagation delay values; to generate a set of probability maps representing these subsets of conditional probability densities for the set of nodes; to combine conditional probability densities represented in a combination of the set of probability maps; and to derive the estimated position-characterized by the greatest probability density in the combination of the set of probability maps-occupied by the target device within the reference coordinate system.

### 2.4 Variation: Time Difference of Arrival Global Optimization

As described herein, the system executes the method S100: to transmit a signal from a target device; to access (or derive) propagation delay values (or time-of-arrival estimates) for the signal received at a set of nodes; and to access positions, in a reference coordinate system, occupied by the set of nodes; to generate probability maps representing probability distributions for the target device occupying positions in the reference coordinate system based on these propagation delay values (or time-of-arrival estimates) and the positions occupied by the nodes; and to calculate an estimated position occupied by the target device within the reference coordinate system based on a combination of the probability maps (e.g., a joint probability distribution) for the set of nodes.

However, the system can similarly execute Blocks of the method S100: to access positions, in a reference coordinate system, occupied by a set of nodes including a reference node; to access time-of-arrival estimates for the signal received at the set of nodes; and to define pairs of nodes in the set of nodes. Each pair of nodes includes a “target” node, in the set of nodes, and the reference node.

For each pair of nodes, the system can execute Blocks of the method S100: to derive a geometric range difference for the pair of nodes based on a first position occupied by the target node, a second position occupied by the reference node, and a candidate position for the target device; to derive an observed range difference for the pair of nodes based on a difference between a first time-of-arrival estimate for the target node and a second time-of-arrival estimate for the reference node; and to derive an error value, in a set of error values, for the pair of nodes based on a difference between the geometric range difference and the observed range difference.

The system can then execute Blocks of the method S100 to compute a solution—for an estimated position, in the reference coordinate system, occupied by the target device—to an objective function that minimizes a sum of the set of error values for a set of candidate positions in the reference coordinate system.

### 3. SYSTEM

Generally, as shown in FIGS. 1A and 1B, the system can include and/or interface with: a set of nodes (e.g., base stations, anchors, 5G gNodeBs, 5G radio units, 5G transmission and reception points, 4G-LTE eNodeBs, wireless tag readers, wireless access points); and a set of devices (e.g., 5G user equipment, mobile phones, 4G-LTE user equipment, passive tags, active tags). Additionally, the system can include and/or interface with a remote computer system (e.g., a remote server).

In one implementation, the system includes a set of nodes (or “receivers”) arranged in a space. For example, the set of nodes can be uniformly distributed in the space.

Each node, in the set of nodes, occupies a known position in a reference coordinate system (e.g., a two-dimensional coordinate system, a three-dimensional coordinate system) representing the space.

In this implementation, the system includes a target device (or “transmitter”) occupying a target (unknown) position in the reference coordinate system.

In another implementation, the system transmits (e.g., broadcasts) a signal (e.g., a ranging signal, a localization signal) from the target device.

For each node in the set of nodes, the system: receives the signal at the node; estimates a channel impulse response of the signal received at the node; and transmits the channel impulse response to the remote computer system. More specifically, the receiver can estimate the channel impulse response characterized by a set of amplitude values—and a set of propagation delay values—that correspond to a set of components of the signal. Additionally or alternatively, the node can: calculate a set of time-of-arrival estimates for the signal received at the node based on the channel impulse response; and transmit the set of time-of-arrival estimates to the remote computer system.

The remote computer system: accesses known positions occupied by the set of nodes; receives a set of channel impulse responses from the set of nodes; and calculates an estimated position (e.g., a maximum likelihood position)—in the reference coordinate system—occupied by the target device based on the set of channel impulse responses (and/or sets of time-of-arrival estimates) and the known positions occupied by the set of nodes.

### 4. MAXIMUM LIKELIHOOD POSITION ESTIMATION

The method S100 includes: accessing a first set of propagation delay values of a first channel impulse response for a localization signal transmitted from a target device and received at a first node in a set of nodes in Block S110; and generating a first probability map in a set of probability maps in Block S120, the first probability map representing a first set of conditional probability masses for a set of positions in a reference coordinate system, each conditional probability mass, in the first set of conditional probability masses, representing a probability mass for the target device occupying a position in the set of positions based on the first set of propagation delay values.

The method S100 includes: accessing a second set of propagation delay values of a second channel impulse response for the localization signal received at a second node in the set of nodes in Block S112; and generating a second probability map in the set of probability maps in Block S122, the second probability map representing a second set of conditional probability masses for the set of positions, each conditional probability mass, in the second set of conditional probability masses, representing a probability mass for the target device occupying a position in the set of positions based on the second set of propagation delay values.

The method S100 includes: generating a composite probability map based on the set of probability maps in Block S126, the composite probability map representing a third set of conditional probability masses for the set of positions based on a product of the first set of conditional probability masses and the second set of conditional probability masses; and calculating an estimated position, in the set of positions, occupied by the target device based on the composite probability map in Block S128, the estimated position characterized by a greatest probability mass in the third set of conditional probability masses.

Generally, in Blocks S110, S112, S114, S116, S120, S122, S124, S126, and S128, the system can: access a set of channel impulse responses—representing a set of propagation delay values—from a set of nodes; calculate probability distributions for positions, in a reference coordinate system, of a target device based on the set of channel impulse responses; and calculate an estimated position, within the reference coordinate system, occupied by the target device based on a combination of the probability distributions (e.g., a joint probability distribution), the estimated position characterized by the greatest probability mass (or the greatest probability density) (e.g., the greatest likelihood) in the combination of the probability distributions based on the set of propagation delay values.

More specifically, for each node in the set of nodes, the system can access a channel impulse response of a signal (e.g., a ranging signal, a localization signal) transmitted from the target device and received at the node. The channel impulse response is characterized by a subset of propagation delay values, in the set of propagation delay values, corresponding to a set of components (e.g., a line-of-sight component, multipath components) of the signal.

For each propagation delay value in the subset of propagation delay values, the system can calculate a subset of conditional probability masses (or conditional probability densities—in a set of conditional probability masses (or conditional probability densities)—for the target device occupying positions within a reference coordinate system based on the propagation delay value and a known position of the node in the reference coordinate system.

For each node in the set of nodes, the system can generate a probability map (or a probability distribution)—in a set of probability maps and for the node—representing the set of conditional probability masses (or conditional probability densities based on the subset of propagation delay values.

The system can calculate the estimated position of the target device within the reference coordinate system based on a combination of the set of probability maps, the estimated position characterized by the greatest probability mass (or the greatest probability density) according to the combination of the set of probability maps based on the set of propagation delay values.

Therefore, the system can: designate each propagation delay value as a candidate propagation delay value for a line-of-sight component of the signal transmitted from the target device and received at a node in the set of nodes; calculate subsets of conditional probability masses for the target device occupying positions within the reference coordinate system based on the propagation delay values; generate a set of probability maps (e.g., probability distributions) representing subsets of conditional probability masses for the set of nodes; combine conditional probability masses represented in a combination of the set of probability maps (e.g., a joint probability distribution); and derive the estimated position-characterized by the greatest probability mass in the combination of the set of probability maps-occupied by the target device within the reference coordinate system, thereby improving accuracy of position estimation when propagation delay values for line-of-sight components of the signal are unknown (or uncertain).

### 4.1 Channel Impulse Response

In one implementation, the target device: generates a signal x(t); modulates the signal by a frequency ω=2πf in a set of frequencies (e.g., based on a carrier frequency hopping scheme or multiple subcarriers with orthogonal frequency division multiplexing); and transmits the signal through a channel h(t).

In another implementation, a node j: receives the signal y(t) transmitted from the target device; and calculates (or characterizes) the channel impulse response hⱼ (t) for the signal y(t) received at the node j, wherein:

$$\begin{matrix}y ( t ) = x ( t ) * h ( t ) \\ {h}_{j} ( t ) = {{\sum }^{{N}_{j}}}_{i = 1} {α}_{i , j} δ ( t - {τ}_{i , j} )\end{matrix}$$

Accordingly, the node j can characterize the channel impulse response Mⱼ as a set of amplitude values α_{i,j}—and a set of propagation delay values τ_{i,j}—that correspond to a set of components of the signal, wherein:

$${M}_{j} = \{ {α}_{i , j} , {τ}_{i , j} \vert i = 1 , 2 , … , {N}_{j} \}$$

More specifically, Nⱼ corresponds to a quantity of components in the set of components of the localization signal received at the node j.

In another implementation, the node j transmits the channel impulse response Mⱼ (e.g., the set of amplitude values α_{i,j} and/or the set of propagation delay values τ_{i,j}) to the remote computer system.

The system executes the foregoing methods and techniques for each node in the set of nodes: to receive the signal at the node; to calculate a channel impulse response—characterized by a set of propagation delay values—for the signal received at the node; and to transmit the channel impulse response to the remote computer system.

### 4.2 First Probability Map

In one implementation, in Block S110, the remote computer system accesses a first channel impulse response M₁ for the signal received at the first node j₁. In this implementation, the first channel impulse response M₁ is characterized by a first set of propagation delay values for a first set of components of the signal, wherein:

$${M}_{1} = \{ {α}_{i , 1} , {τ}_{i , 1} \vert i = 1 , 2 , … , {N}_{1} \}$$

For example, the system can access the first set of propagation delay values absent identification of a target propagation delay value, in the first set of propagation delay values, associated with a line-of-sight component in the first set of components of the signal. In this example, the set of components can include: the line-of-sight component that is deterministic with respect to position; and a set of multipath components that are random with respect to position.

In another implementation, in Block S120, the remote computer system generates a first probability map—representing a first set of conditional probability masses for a set of positions of a reference coordinate system—for the first node j, based on the first set of propagation delay values. Each position, in the set of positions, is characterized by a set of coordinates in the reference coordinate system. Each conditional probability mass, in the first set of conditional probability masses, represents a probability mass for the target device occupying a position x in the set of positions based on the first set of propagation delay values.

For example, for a first propagation delay value (e.g., τ_{1,1}) in the first set of propagation delay values, the remote computer system can calculate a first subset of conditional probability masses P(x|τ=τ_{1,1}), in the first set of conditional probability masses, representing probability masses for the target device occupying positions in the set of positions based on the first propagation delay value and a first position, in the reference coordinate position, occupied by the first node.

In this example, for a second propagation delay value (e.g., τ_{2,1}) in the first set of propagation delay values, the remote computer system can calculate a second subset of conditional probability masses P(x|τ=τ_{2,1}), in the first set of conditional probability masses, representing probability masses for the target device occupying positions in the set of positions based on the second propagation delay value and the first position occupied by the first node.

The system can repeat the foregoing methods and techniques for each propagation delay value in the first set of propagation delay values to calculate a subset of conditional probability masses—in the first set of conditional probability masses—representing probability masses for the target device occupying positions in the set of positions based on the propagation delay value and the first position occupied by the first node.

In this example, the remote computer system can generate the first probability map representing a sum of subsets of conditional probability masses—including the first subset of conditional probability masses and the second subset of conditional probability masses—in the first set of conditional probability masses,

$${\sum }_{i = 1}^{{N}_{1}} P ( x \vert τ = {τ}_{i , 1} ) .$$

### 4.3 Additional Probability Maps

The system executes the foregoing methods and techniques for each node in the set of nodes: to access a channel impulse response—characterized by a set of propagation delay values—for the signal transmitted by the target device and received at the node; to calculate a set of conditional probability masses for the set of positions based on the set of propagation delay values and a known position, in the reference coordinate system, occupied by the node; and to generate a probability map for the node based on the set of propagation delay values. Each conditional probability mass, in the set of conditional probability masses, represents a probability mass for the target device occupying a position in the set of positions based on the set of propagation delay values.

For example, in Block S112, the remote computer system can access a second channel impulse response M₂—characterized by a second set of propagation delay values—for the signal received at a second node j₂, wherein:

$${M}_{2} = \{ {α}_{i , 2} , {τ}_{i , 2} \vert i = 1 , 2 , … , {N}_{2} \}$$

In this example, in Block S122, the remote computer system can generate a second probability map—representing a second set of conditional probability masses for the set of positions of the reference coordinate system—for the second node j₂ based on the second set of propagation delay values. Each conditional probability mass, in the second set of conditional probability masses, represents a probability mass for the target device occupying a position x in the set of positions based on the second set of propagation delay values.

More specifically, for each propagation delay value in the second set of propagation delay values, the remote computer system can calculate a subset of conditional probability masses P(x|τ=τ_{1,2})—in the second set of conditional probability masses—representing probability masses for the target device occupying positions in the set of positions based on the propagation delay value and a second position, in the reference coordinate system, occupied by the second node.

The remote computer system can then generate the second probability map representing a sum of subsets of conditional probability masses in the second set of conditional probability masses,

$${\sum }_{i = 1}^{{N}_{2}} P ( x \vert τ = {τ}_{i , 2} ) .$$

### 4.4 Maximum Likelihood Position

Generally, the system can characterize the position x occupied by the target device within the reference coordinate system based on a probability distribution (e.g., a joint probability distribution) for a set of channel impulse responses M₁, M₂, . . . , M_{K} for the set of nodes (e.g., K nodes) according to (e.g., given) the position x of the target device, wherein:

$$\hat{x} = arg {max}_{x} P ( {M}_{1} , {M}_{2} , … , {M}_{K} \vert x ) \qquad ( Equation 1 )$$

More specifically, because receiver noise for these anchors is independent of each other, the system can characterize the probability distribution of the set of channel impulse responses for the set of nodes given the position x of the target device as:

$$P ( {M}_{1} , {M}_{2} , … , {M}_{K} \vert x ) = {{\prod }^{K}}_{k = 1} P ( {M}_{k} \vert x )$$

The system can characterize a particular probability distribution for a particular channel impulse response given the position x of the target device as:

$$P ( {M}_{k} \vert x ) = \frac{P ( x \vert {M}_{k} ) P ( {M}_{k} )}{P ( x )}$$

More specifically, the system can define: P(Mₖ) as independent of the node k; α_{i,j} and τ_{i,j} in Mₖ as uniformly distributed; and the position x of the target device as uniformly distributed in the reference coordinate system.

Accordingly, the system can characterize maximization in Equation 1 as independent of P(Mₖ) and P(x).

Additionally, the system can calculate a probability distribution for the position x according to the particular channel impulse response, wherein:

$$\begin{matrix}P ( x \vert {M}_{k} ) = {{\sum }^{{N}_{k}}}_{i = 1} P ( x \vert τ = {τ}_{i , k} ) P ( τ = {τ}_{i , k} ) \\ P ( x \vert {M}_{k} ) = p {{\sum }^{{N}_{k}}}_{i = 1} P ( x \vert τ = {τ}_{i , k} )\end{matrix} \qquad ( Equation 2 )$$

More specifically, the system can define p=P(τ=τ_{i,k}) for discrete random variable τ corresponding to a delay grid value in a set of delay grid values.

Accordingly, based on Equation 2, the system can characterize Equation 1 as:

$$\begin{matrix}\begin{matrix}\hat{x} = arg {max}_{x} P ( {M}_{1} , {M}_{2} , … , {M}_{K} \vert x ) \\ \hat{x} = arg {max}_{x} {{\prod }^{K}}_{k = 1} P ( {M}_{k} \vert x )\end{matrix} \\ \hat{x} = arg {max}_{x} C {{\prod }^{K}}_{k = 1} ( {{\sum }^{{N}_{k}}}_{i = 1} P ( x \vert τ = {τ}_{i , k} ) )\end{matrix}$$

In particular, the system characterizes C as a combination of all probabilities (or probability distributions) independent of k. Therefore, the system can calculate the estimated position \hat{x} occupied by the target device within the reference coordinate system, wherein:

$$\hat{x} = arg {max}_{x} {{\prod }^{K}}_{k = 1} ( {{\sum }^{{N}_{k}}}_{i = 1} P ( x \vert τ = {τ}_{i , k} ) )$$

In one implementation, in Block S126, the remote computer system generates a composite probability map based on the set of probability maps. The composite probability map represents a composite set of conditional probability masses—for the set of positions of the reference coordinate system—based on a product of a set of conditional probability masses for each probability map in the set of probability maps.

More specifically, the remote computer system can calculate the composite set of conditional probability masses by multiplying sets of conditional probability masses represented by the set of probability maps, the composite set of conditional probability masses represented as:

$${{\prod }^{K}}_{k = 1} ( {{\sum }^{{N}_{k}}}_{i = 1} P ( x \vert τ = {τ}_{i , k} ) )$$

For example, the remote computer system can generate a composite probability map based on the set of probability maps including: the first probability map representing the first set of conditional probability masses; and the second probability map representing the second set of conditional probability masses.

In this example, the remote computer system can generate the composite probability map representing a third set of conditional probability masses based on a product of the first set of conditional probability masses and the second set of conditional probability masses.

In another implementation, in Block S128, the remote computer system calculates the estimated position \hat{x}—in the set of positions of the reference coordinate system—occupied by the target device based on the composite probability map. The estimated position & is characterized by the greatest probability mass in the composite set of conditional probability masses, wherein:

$$\hat{x} = arg {max}_{x} {{\prod }^{K}}_{k = 1} ( {{\sum }^{{N}_{k}}}_{i = 1} P ( x \vert τ = {τ}_{i , k} ) )$$

### 4.5 Variation: Additional Localization Signals

In one variation, the system executes the foregoing methods and techniques for each node in the set of nodes: to access a channel impulse response, characterized by a set of propagation delay values, for a first signal transmitted by the target device (e.g., a first localization signal transmitted at a first time during a first time period) and received at the node; to calculate subsets of conditional probability masses—in a set of conditional probability masses—representing probability masses for the target device occupying positions in the set of positions based on propagation delay values, in the set of propagation delay values, and a position occupied by the node; and to generate a probability map, in a set of probability maps, for the node representing the set of conditional probability masses based on the set of propagation delay values.

For example, the system can execute the foregoing methods and techniques: to access a first set of propagation delay values of a first channel impulse response for a first signal transmitted by the target device and received at the first node; to calculate subsets of conditional probability masses, in a first set of conditional probability masses, representing probability masses for the target device occupying positions—in a set of positions of the reference coordinate system—based on propagation delay values, in the first set of propagation delay values, and the first position occupied by the first node; and to generate a first probability map, in the set of probability maps, for the first node representing the first set of conditional probability masses based on the first set of propagation delay values.

In this example, the system can execute the foregoing methods and techniques: to access a second set of propagation delay values of a second channel impulse response for the first signal transmitted by the target device and received at the second node; to calculate subsets of conditional probability masses, in a second set of conditional probability masses, representing probability masses for the target device occupying positions—in the set of positions of the reference coordinate system—based on propagation delay values, in the second set of propagation delay values, and the second position occupied by the second node; and to generate a second probability map, in the set of probability maps, for the second node representing the second set of conditional probability masses based on the second set of propagation delay values.

In this variation, the system executes the foregoing methods and techniques: to access a third set of propagation delay values of a third channel impulse response for a second signal transmitted by the target device (e.g., a second localization signal transmitted during a second time succeeding the first time period) and received at the first node; to calculate subsets of conditional probability masses, in a third set of conditional probability masses, representing probability masses for the target device occupying positions—in the set of positions—based on propagation delay values, in the third set of propagation delay values, and the first position occupied by the first node; and to generate a third probability map, in the set of probability maps, for the first node representing the third set of conditional probability masses based on the third set of propagation delay values.

The system repeats the foregoing methods and techniques for each node in the set of nodes: to access a channel impulse response, characterized by a set of propagation delay values, for the second signal transmitted by the target device and received at the node; to calculate subsets of conditional probability masses—in a set of conditional probability masses—representing probability masses for the target device occupying positions in the set of positions based on propagation delay values, in the set of propagation delay values, and a position occupied by the node; and to generate a probability map, in a set of probability maps, for the node representing the set of conditional probability masses based on the set of propagation delay values.

For example, the system executes the foregoing methods and techniques: to access a fourth set of propagation delay values of a fourth channel impulse response for the second signal transmitted by the target device and received at the second node; to calculate subsets of conditional probability masses, in a fourth set of conditional probability masses, representing probability masses for the target device occupying positions—in the set of positions—based on propagation delay values, in the fourth set of propagation delay values, and the second position occupied by the first node; and to generate a fourth probability map, in the set of probability maps, for the second node representing the fourth set of conditional probability masses based on the fourth set of propagation delay values.

In this variation, the system executes the foregoing methods and techniques to generate a composite probability map based on the set of probability maps. The composite probability map represents a composite set of conditional probability masses—for the set of positions of the reference coordinate system—based on a product of a set of conditional probability masses for each probability map in the set of probability maps. For example, the system can generate the composite probability map representing a composite set of conditional probability masses based on a product of: the first set of conditional probability masses represented in the first probability map; the second set of conditional probability masses represented in the second probability map; the third set of conditional probability masses represented in the third probability map; and the fourth set of conditional probability masses represented in the fourth probability map.

Accordingly, rather than generating a composite probability map based on a set of probability maps associated with a single localization signal transmitted by a target device, the system can: generate the set of probability maps for the set of nodes based on known positions occupied by the set of nodes and reception of a series of localization signals—transmitted by the target device—over time at these nodes; generate the composite probability map based on the set of probability maps; and calculate the estimated position occupied by the target device based on the composite probability map in order to increase a quantity of measurements for localizing the target device, thereby improving accuracy of the estimated position occupied by the target device (e.g., when the target device is stationary).

### 4.6 Variation: Three-Dimensional Reference Coordinate System

In another variation, in Block S102, the system defines a set of altitude grid values. Each altitude grid value—in the set of altitude grid values—corresponds to a candidate altitude, in the reference coordinate system, for the target device. For example, the remote computer system can define the set of altitude grid values exhibiting an increment δz (e.g., one meter).

In this variation, the system executes the foregoing methods and techniques for each node in the set of nodes: to access a channel impulse response—characterized by a set of propagation delay values—for the signal transmitted by the target device and received at the node; to calculate a set of conditional probability masses for the set of positions based on the set of propagation delay values, a first altitude grid value in the set of altitude grid values, and a known position, in the reference coordinate system, occupied by the node; and to generate a probability map for the node based on the set of propagation delay values. Each conditional probability mass, in the set of conditional probability masses, represents a probability mass for the target device occupying a position in the set of positions based on the set of propagation delay values.

For example, the first node can execute the foregoing methods and techniques: to access a first channel impulse response—characterized by a first set of propagation delay values—for the signal transmitted by the target device and received at the first node; to calculate a first set of conditional probability masses for the set of positions based on the first set of propagation delay values, the first altitude grid value, and the first position occupied by the first node; and to generate a first probability map for the first node based on the first set of propagation delay values.

The system can repeat the foregoing methods and techniques for each node in the set of nodes. In one example, the second node executes the foregoing methods and techniques: to access a second channel impulse response—characterized by a second set of propagation delay values—for the signal transmitted by the target device and received at the second node; to calculate a second set of conditional probability masses for the set of positions based on the second set of propagation delay values, the first altitude grid value, and the second position occupied by the first node; and to generate a second probability map for the first node based on the second set of propagation delay values.

The system then executes the foregoing methods and techniques: to generate a first composite probability map—for the first altitude grid value—based on the first set of probability maps; and to calculate a first candidate position, in the set of positions of the reference coordinate system, occupied by the target device based on the first composite probability map. More specifically: the first composite probability map represents a first composite set of conditional probability masses—for the set of positions, of the reference coordinate system, characterized by the first altitude grid value—based on a product of a set of conditional probability masses for each probability map in the first set of probability maps; and the first candidate position is characterized by greatest probability mass in the first composite set of conditional probability masses.

In this variation, the system repeats the foregoing methods and techniques for each altitude grid value in the set of altitude grid values: to generate a set of probability maps for the set of nodes based on sets of propagation delay values, the altitude grid value, and known positions of the set of nodes; to generate a composite probability map—in a set of composite probability maps—for the altitude grid value based on the set of probability maps; and to calculate a candidate position, in a set of candidate positions, occupied by the target device based on the composite probability map.

For example, the system executes the foregoing methods and techniques: to calculate a third set of conditional probability masses for the set of positions based on the first set of propagation delay values, a second altitude grid value in the set of altitude grid values, and the first position occupied by the first node; and to generate a third probability map—in a second set of probability maps—representing the third set of conditional probability masses.

In this example, the system repeats the foregoing methods and techniques: to calculate a fourth set of conditional probability masses for the set of positions based on the second set of propagation delay values, the second altitude grid value in the set of altitude grid values, and the first position occupied by the first node; and to generate a fourth probability map—in the second set of probability maps—for the second node representing the fourth set of conditional probability masses.

In this example, the system then executes the foregoing methods and techniques: to generate a second composite probability map—for the second altitude grid value—based on the second set of probability maps; and to calculate a second candidate position, in the set of positions of the reference coordinate system, occupied by the target device based on the second composite probability map. More specifically: the second composite probability map represents a second composite set of conditional probability masses—for the set of positions, of the reference coordinate system, characterized by the second altitude grid value—based on a product of a set of conditional probability masses for each probability map in the second set of probability maps; and the second candidate position is characterized by greatest probability mass in the second composite set of conditional probability masses.

In this variation, the system calculates the estimated position occupied by the target device based on the set of composite probability maps, the estimated position characterized by the greatest probability mass in the set of composite probability maps.

More specifically, the system can access the set of candidate positions, each candidate position, in the set of candidate positions, characterized by a probability mass in a group of conditional probability masses. The system can then select a target candidate position—in the set of candidate positions and characterized by the greatest probability mass in the group of conditional probability masses—as the estimated position occupied by the target device.

Accordingly, for each altitude grid value in the set of altitude grid values, the system can: generate a set of probability maps for the set of nodes based on sets of propagation delay values, the altitude grid value, and known positions of the set of nodes; generate a composite probability map, in a set of composite probability maps, for the altitude grid value based on the set of probability maps; and calculate a candidate position—in a set of candidate positions and characterized by the altitude grid value—occupied by the target device based on the composite probability map. Therefore, the system can identify a target candidate position—characterized by a probability mass (e.g., the greatest probability mass) exceeding probability masses for other candidate positions in the set of candidate positions—as the estimated position occupied by the target device within a three-dimensional coordinate system.

### 4.7 Variation: Time of Arrival Maximum Likelihood Positioning

In another variation, the remote computer system accesses a first set of time-of-arrival estimates for the signal received at the first node.

For example, the first node can: calculate the first channel impulse response—characterized by the first set of propagation delay values—for the signal transmitted from the target device and received at the first node; calculate the first set of time-of-arrival estimates for the signal based on the first set of propagation delay values; and transmit the first set of time-of-arrival estimates to the remote computer system.

In this variation, the remote computer system executes similar methods and techniques described above to generate a first probability map—in a set of probability maps and representing a first set of conditional probability masses for a set of positions of a reference coordinate system—for the first node based on the first set of time-of-arrival estimates.

For example, for each time-of-arrival estimate in the first set of time-of-arrival estimates, the remote computer system can execute similar methods and techniques described above to calculate a subset of conditional probability masses—in the first set of conditional probability masses—representing probability masses for the target device occupying positions in the set of positions based on the time-of-arrival estimate and the first position occupied by the first node. The remote computer system can then generate the first probability map representing a sum of subsets of conditional probability masses in the first set of conditional probability masses.

The remote computer system repeats the foregoing methods and techniques for each node in the set of nodes: to access a set of time-of-arrival estimates for the signal received at the node; and to generate a probability map—in the set of probability maps—for the node based on the set of time-of-arrival estimates and a known position occupied by the node.

In this variation, the system executes the foregoing methods and techniques: to generate a composite probability map representing a composite set of conditional probability masses based on the set of probability maps; and to calculate an estimated position—characterized by the greatest probability mass in the composite set of conditional probability masses—occupied by the target device based on the composite probability map.

### 4.8 Variation: Time Difference of Arrival Maximum Likelihood Positioning

In another variation, as shown in FIG. 3, the system executes the foregoing methods and techniques for each node in the set of nodes to access a channel impulse response—characterized by a set of propagation delay values—for the signal transmitted by the target device and received at the node.

For example, the system can execute the foregoing methods and techniques: to access the first set of propagation delay values of the first channel impulse response for the signal received at the first node in Block S102; and to access a set of reference propagation delay values of a reference channel impulse response for the signal received at a reference node in the set of nodes.

In this variation, the system: calculates a first difference between a first propagation delay value, in the first set of propagation delay values, and a first reference propagation delay value in the set of reference propagation delay values; and calculates a first subset of conditional probability masses (e.g., a first hyperbola—about a first known position of the first node and a second known position of the reference node in the reference coordinate system—characterized by non-zero probability mass values)—in a first set of conditional probability masses—for a set of positions of the reference coordinate system based on the first difference and a first position, in the set of positions, occupied by the first node. Each conditional probability mass, in the first subset of conditional probability masses, represents a probability mass for the target device occupying a position in the set of positions of the reference coordinate system based on the first difference and the first position.

The system repeats the foregoing methods and techniques for each propagation delay value in the first set of propagation delay values: to calculate a difference between the propagation delay value, in the first set of propagation delay values, and the first reference propagation delay value; and to calculate a subset of conditional probability masses—in the first set of conditional probability masses—for the set of positions based on the difference, between the propagation delay value and the first reference propagation delay value, and the first position occupied by the first node.

The system repeats the foregoing methods and techniques for each reference propagation delay value in the set of reference propagation delay values: to calculate a difference between each propagation delay value, in the first set of propagation delay values, and the reference propagation delay value; and to calculate a subset of conditional probability masses, in the first set of conditional probability masses, for the set of positions based on the difference—between the propagation delay value, in the first set of propagation delay values, and the reference propagation delay value—and the first position occupied by the first node.

In this variation, the system executes the foregoing methods and techniques to generate a first probability map—in a set of probability maps—for the first node representing a sum of subsets of conditional probability masses in the first set of conditional probability masses in Block S120.

The system repeats the foregoing methods and techniques for each node in the set of nodes: to calculate subsets of conditional probability masses, in a set of conditional probability masses, for the set of positions based on differences—between propagation delay values, in a set of propagation delay values for the node, and reference propagation delay values in the set of reference propagation delay values—and a position, in the set of positions, occupied by the node; and to generate a probability map, in a set of probability maps, for the node representing a sum of subsets of conditional probability masses in the set of conditional probability masses.

For example, the system can execute the foregoing methods and techniques: to access the second set of propagation delay values of the second channel impulse response for the signal received at the second node; to calculate a third difference between a third propagation delay value, in the second set of propagation delay values, and the first reference propagation delay value in the set of reference propagation delay values; and to calculate a third subset of conditional probability masses—in a second set of conditional probability masses—for the set of positions based on the third difference and a second position, in the set of positions, occupied by the second node. Each conditional probability mass, in the third subset of conditional probability masses, represents a probability mass for the target device occupying a position in the set of positions based on the third difference and the second position.

In this variation, the system executes the foregoing methods and techniques to generate a composite probability map based on the set of probability maps in Block S126. The composite probability map represents a composite set of conditional probability masses—for the set of positions of the reference coordinate system—based on a product of a set of conditional probability masses for each probability map in the set of probability maps. The system can then execute the foregoing methods and techniques to calculate an estimated position—characterized by the greatest probability mass in the composite set of conditional probability masses—occupied by the target device based on the composite probability map in Block S128.

As described herein, the system executes Blocks of the method S100: to generate a set of probability maps for the set of nodes based on known positions of the set of nodes and differences between sets of propagation delay values and reference propagation delay values; to generate a composite probability map based on the set of probability maps; and to calculate the estimated position—characterized by the greatest probability mass-occupied by the target device based on the composite probability map.

However, the system can similarly execute Blocks of the method S100: to access sets of time-of-arrival estimates for the signal received at the set of nodes; to calculate differences—or “time differences of arrival”—between these time-of-arrival estimates and reference time-of-arrival estimates received at a reference node in the set of nodes; to generate a set of probability maps, for the set of nodes, representing conditional probability masses for the set of positions based on known positions of the set of nodes and the time differences of arrival; and to calculate the estimated position—characterized by the greatest probability mass—occupied by the target device based on the composite probability map.

For example, the remote computer system can: access the first set of time-of-arrival estimates for the signal received at the first node; access a set of reference time-of-arrival estimates for the signal received at the reference node; and calculate a first time difference of arrival corresponding to a difference between a first time-of-arrival estimate, in the first set of time-of-arrival estimates, and a first reference time-of-arrival estimate in the set of reference time-of-arrival estimates; and calculate a first subset of conditional probability masses—in a first set of conditional probability masses—for a set of positions of the reference coordinate system based on the first time difference of arrival and a first position, in the set of positions, occupied by the first node. Each conditional probability mass, in the first subset of conditional probability masses, represents a probability mass for the target device occupying a position in the set of positions based on the first time difference of arrival and the first position.

In this example, the system can execute the foregoing methods and techniques for each time-of-arrival estimate in the first set of time-of-arrival estimates and for each reference time-of-arrival estimate in the set of reference time-of-arrival estimates to generate subsets of conditional probability masses—in the first set of conditional probability masses—based on time differences of arrival and the first position occupied by the first node. The system can then execute the foregoing methods and techniques to generate a first probability map, in the set of probability maps, representing the first set of conditional probability masses.

Therefore, the system can: generate a set of probability maps for the set of nodes based on known positions of the set of nodes and time differences of arrival of the signal received at these nodes; to generate a composite probability map based on the set of probability maps; and calculate the estimated position—characterized by the greatest probability mass-occupied by the target device based on the composite probability map in order to improve accuracy of time-difference-of-arrival-based position estimation when time-of-arrival estimates for line-of-sight components of the signal are unknown (or uncertain).

### 5. MULTI-PHASE MAXIMUM LIKELIHOOD POSITION ESTIMATION

The method S100 includes, during a first time period: defining a set of delay grid values in Block S102, each delay grid value, in the set of delay grid values, corresponding to a candidate propagation delay of a candidate signal transmitted from a candidate device and received at a node in a set of nodes; calculating a first subset of conditional probability masses for a first node in the set of nodes in Block S104; and calculating a second subset of conditional probability masses for a second node in the set of nodes in Block S106. Each conditional probability mass, in the first subset of conditional probability masses, represents a probability mass for the candidate device occupying a position in a set of positions of a reference coordinate system based on a first delay grid value, in the set of delay grid values, and a first position, in the reference coordinate system, occupied by the first node. Each conditional probability mass, in the second subset of conditional probability masses, represents a probability mass for the candidate device occupying a position in the set of positions based on a second delay grid value, in the set of delay grid values, and a second position, in the reference coordinate system, occupied by the second node.

The method S100 includes, during a second time period succeeding the first time period: accessing a first set of propagation delay values for a localization signal transmitted from a target device received at the first node in Block S110; accessing a second set of propagation delay values for the localization signal received at the second node in Block S112; accessing the first subset of conditional probability masses in response to detecting correspondence between a first propagation delay value, in the first set of propagation delay values, and the first delay grid value in Block S114; accessing the second subset of conditional probability masses in response to detecting correspondence between a second propagation delay value, in the second set of propagation delay values, and the second delay grid value in Block S116; and calculating a composite set of conditional probability masses based on a product of the first subset of conditional probability masses and the second subset of conditional probability masses in Block S124. Each conditional probability mass, in the set of conditional probability masses, represents a probability mass for the target device occupying a position in the set of positions based on the first set of propagation delay values and the second set of propagation delay values.

Block S128 of the method S100 recites calculating an estimated position, in the set of positions, occupied by the target device. The estimated position is characterized by a greatest probability mass in the composite set of conditional probability masses.

Generally, in Blocks S102, S104, S106, and S108, the system can: define a set of delay grid values corresponding to candidate propagation delays of a candidate signal transmitted from a candidate device and received at a node in a set of nodes deployed in a space; calculate conditional probability masses for positions, in a reference coordinate system representing the space, of the candidate device based on a delay grid value in the set of delay grid values and a position, in the reference coordinate system, occupied by the node; and store these conditional probability masses in a data repository (e.g., a database) in association with the node and the delay grid value. The system can repeat the foregoing methods and techniques for each delay grid value in the set of delay grid values and for each node in the set of nodes.

In Blocks S110, S112, S114, S116, S120, and S122, the system can later: access a set of propagation delay values of a channel impulse response for a signal (e.g., a localization signal) transmitted from a target device and received at a node; identify delay grid values that correspond to the set of propagation delay values; retrieve conditional probability masses associated with the node and the delay grid values from the data repository; and generate a probability map, in a set of probability maps, for the node based on a sum of these conditional probability masses. The system can repeat the foregoing methods and techniques for delay grid value in the set of delay grid values and for each node in the set of nodes.

In Blocks S124, S126, and S128, the system can then execute the foregoing methods and techniques: to generate a composite probability map based on the set of probability maps; and to calculate an estimated position, in the reference coordinate system, occupied by the target device based on the composite probability map. The estimated position is characterized by the greatest probability mass in the composite probability map.

Therefore, for each node in the set of nodes, the system can: pre-compute a corpus of conditional probability masses for the node during an offline processing phase; selectively retrieve conditional probability masses from the corpus of conditional probability masses during a subsequent online processing phase based on propagation delay values for a signal transmitted by the target device and received at the node; and to assemble selected conditional probability masses into a joint probability distribution for positions in the reference coordinate system in order to reduce response time and/or computational cost to calculate the estimated position of the target device based on these conditional probability masses.

### 5.1 Grid Values

In one implementation, in Block S102, the system defines a set of delay grid values. Each delay grid value τ, in the set of delay grid values, corresponding to a candidate propagation delay of a component (e.g., a line-of-sight component, a multipath component) of a candidate signal transmitted from a candidate device and received at a node. For example, the system can define the set of delay grid values characterized by an increment δt (e.g., one nanosecond).

Additionally, the system can execute the foregoing methods and techniques to define a set of altitude grid values. Each altitude grid value—in the set of altitude grid values—corresponds to a candidate altitude, in the reference coordinate system, for the candidate device. For example, the remote computer system can define the set of altitude grid values exhibiting an increment δz (e.g., one meter).

### 5.2 Training Phase

In one implementation, in Block S104, the remote computer system calculates a first subset of conditional probability masses, in a first corpus of conditional probability masses for the first node, for the set of positions based on: a first delay grid value (e.g., 100 nanoseconds) in the set of delay grid values; a first altitude grid value in the set of altitude grid values; and the first position, in the reference coordinate system, occupied by the first node. Each conditional probability mass, in the first subset of conditional probability masses, represents a probability mass for the candidate device occupying a position, in a set of positions of the reference coordinate system, based on the first delay grid value, the first altitude grid value, and the first position occupied by the first node.

In this implementation, the remote computer system stores the first subset of conditional probability masses—in association with the first delay grid value, the first altitude grid value, and the first node—in a data repository in Block S108.

In one variation, for each position in the set of positions, the remote computer system calculates a conditional probability mass, in a group of conditional probability masses, for the position representing a probability mass for the candidate device occupying the position based on the first delay grid value, the first altitude grid value, and the first position occupied by the first node.

In this variation, the remote computer system: selects a first subgroup of conditional probability masses (e.g., the first subset of conditional probability masses) in the group of conditional probability masses; and stores the first subgroup of conditional probability masses in the data repository. Each conditional probability mass, in the first subgroup of conditional probability masses, is characterized by a probability mass exceeding a threshold probability mass (e.g., 0.1, 0.5, 0.7, 10%, 50%, 70%).

For example, for each conditional probability mass in the first subgroup of conditional probability masses, the remote computer system can store the conditional probability mass in association with: the first delay grid value; the first altitude grid value; a position (e.g., a set of coordinates in the reference coordinate system), in the set of positions, corresponding to the conditional probability mass; and the first node.

Additionally, the remote computer system can discard a second subgroup of conditional probability masses—different from (e.g., excluding) the first subgroup of conditional probability masses)—from the group of conditional probability masses. Each conditional probability mass, in the second subset of conditional probability masses, is characterized by a probability mass falling below the threshold probability mass.

Therefore, by selectively storing conditional probability mass values exceeding the threshold probability mass, the system reduces memory overhead incurred while storing a corpus of conditional probability masses in the data repository.

In another implementation, the remote computer system repeats the foregoing methods and techniques for each delay grid value (e.g., a second delay grid value) in the set of delay grid values: to calculate a subset of conditional probability masses in the first corpus of conditional probability masses for the first node based on the delay grid value in the set of delay grid values, the first altitude grid value, and the first position occupied by the first node; and to store the subset of conditional probability masses—in association with the delay grid value, the first altitude grid value, and the first node—in the data repository.

Additionally, the remote computer system can repeat the foregoing methods and techniques for each altitude grid value (e.g., a second altitude grid value) in the set of altitude grid values: to calculate a subset of conditional probability masses in the first corpus of conditional probability masses for the first node based on each delay grid value (e.g., the first delay grid value, the second delay grid value) in the set of delay grid values, the altitude grid value, and the first position occupied by the first node; and store the subset of conditional probability masses—in association with the delay grid value, the altitude grid value, and the first node—in the data repository.

In this implementation, the remote computer system repeats the foregoing methods and techniques for each node in the set of nodes: to calculate a corpus of conditional probability masses for the node based on each delay grid value in the set of delay grid values, each altitude grid value in the set of altitude grid values, and a position occupied by the node; and to store the corpus of conditional probability masses in the data repository.

### 5.3 Positioning Phase

In one implementation, during the second time period, the remote computer system executes the foregoing methods and techniques to access a first set of propagation delay values of a first channel impulse response for a localization signal transmitted from a target device and received at the first node. For example, the first set of propagation delay values can include a first propagation delay value of 100.4 nanoseconds, a second propagation delay value of 151.6 nanoseconds, etc.

In this implementation, in Block S114, the remote computer system accesses (or retrieves) the first subset of conditional probability masses for the first node from the data repository in response to detecting correspondence between the propagation delay value and the first delay grid value.

More specifically, in response to accessing the first set of propagation delay values including the first propagation delay value, the remote computer system can: identify a target delay grid value, in the set of delay grid values, corresponding to the first propagation delay value; and retrieve a subset of conditional probability masses—associated with the target delay grid value—for the first node.

For example, in response to accessing the first set of propagation delay values including the first propagation delay value of 100.4 nanoseconds, the remote computer system can: identify the first propagation delay value as corresponding to the first delay grid value of 100 nanoseconds; and retrieve the first subset of conditional probability masses from the data repository according to the first delay grid value corresponding to an index into the data repository.

The remote computer system repeats the foregoing methods and techniques for each propagation delay value in the first set of propagation delay values: to identify a delay grid value, in the set of delay grid values, corresponding to the propagation delay value; and to retrieve the subset of conditional probability masses from the data repository.

In response to accessing subsets of conditional probability masses for the first node, the remote computer system executes the foregoing methods and techniques: to calculate a first set of conditional probability masses for the set of positions based on a sum of the subsets of conditional probability masses; and to generate a first probability map, in a set of probability maps, representing the first set of conditional probability masses.

The remote computer system repeats the foregoing methods and techniques for each node in the set of nodes: to access a set of propagation delay values of a channel impulse response for the localization signal received at the node; to retrieve subsets of conditional probability masses for the node from the data repository based on the set of propagation delay values; to calculate a set of conditional probability masses for the set of positions based on a sum of the subsets of conditional probability masses; and to generate a probability map, in a set of probability maps, representing the set of conditional probability masses.

In another implementation, the remote computer system executes the foregoing methods and techniques: to calculate a composite set of conditional probability masses for the set of positions based on the set of probability maps (e.g., based on a product of sets of conditional probability masses for the set of nodes); and to generate a composite probability map representing the composite set of conditional probability masses.

In another implementation, the remote computer system executes the foregoing methods and techniques to calculate an estimated position, in the set of positions, occupied by the target device based on the composite probability map. The estimated position is characterized by the greatest probability mass in the composite set of conditional probability masses.

Therefore, for each node in the set of nodes, the system can: access a set of propagation delay values for the localization signal received at the node; index a corpus of conditional probability masses for the node to compile pre-computed subsets of conditional probability masses for the set of propagation delay values; and generate a probability map—in a set of probability maps—for the node based on these subsets of conditional probability masses, thereby enabling the system to calculate the estimated position of the target device based on the set of probability maps while reducing response time and multipath-induced error.

### 5.4 Positioning Phase for Three-Dimensional Coordinate System

In one variation, for each node in the set of nodes, the remote computer system executes the foregoing methods and techniques: to access a channel impulse response—characterized by a set of propagation delay values—for the signal transmitted by the target device and received at the node; to identify a subset of delay grid values, in the set of delay grid values, corresponding to the set of propagation delay values; to retrieve subsets of conditional probability masses—associated with a first altitude grid value in the set of altitude grid values—for the node from the data repository according to the subset of delay grid values; to calculate a first set of conditional probability masses for the set of positions characterized by the first altitude grid value based on a sum of the subsets of conditional probability masses; and to generate a probability map, in a first set of probability maps, representing the first set of conditional probability masses.

The remote computer system then executes the foregoing methods and techniques: to calculate a first composite set of conditional probability masses—for the set of positions characterized by the first altitude grid value—based on the first set of probability maps (e.g., based on a product of sets of conditional probability masses for the set of nodes); to generate a first composite probability map, in a set of composite probability maps and for the first altitude grid value, representing the first composite set of conditional probability masses; and to calculate a first candidate position, in the set of positions of the reference coordinate system, occupied by the target device based on the first composite probability map. More specifically: the first composite probability map represents the first composite set of conditional probability masses—for the set of positions, of the reference coordinate system, characterized by the first altitude grid value—based on a product of a set of conditional probability masses for each probability map in the first set of probability maps; and the first candidate position is characterized by greatest probability mass in the first composite set of conditional probability masses.

In this variation, the remote computer system repeats the foregoing methods and techniques for each altitude grid value in the set of altitude grid values: to retrieve subsets of conditional probability masses—associated with the altitude grid value in the set of altitude grid values—for each node in the set of nodes; to calculate sets of conditional probability masses for the set of positions characterized by the altitude grid value based on the subsets of conditional probability masses; to generate a composite probability map—in the set of composite probability maps—for the altitude grid value based on the set of probability maps; and to calculate a candidate position, in a set of candidate positions, occupied by the target device based on the composite probability map.

In this variation, the system calculates the estimated position occupied by the target device based on the set of composite probability maps, the estimated position characterized by the greatest probability mass in the set of composite probability maps.

More specifically, the system can access the set of candidate position, each candidate position—in the set of candidate positions—characterized by a probability mass in a group of conditional probability masses. The system can then select a target candidate position—in the set of candidate positions and characterized by the greatest probability mass in the group of conditional probability masses—as the estimated position occupied by the target device.

Accordingly, for each altitude grid value in the set of altitude grid values, the system can: generate a set of probability maps for the set of nodes based on sets of propagation delay values, the altitude grid value, and known positions of the set of nodes; generate a composite probability map, in a set of composite probability maps, for the altitude grid value based on the set of probability maps; and calculate a candidate position—in a set of candidate positions and characterized by the altitude grid value—occupied by the target device based on the composite probability map. Therefore, the system can identify a target candidate position—characterized by a probability mass (e.g., the greatest probability mass) exceeding probability masses of other candidate positions in the set of candidate positions—as the estimated position occupied by the target device within a three-dimensional coordinate system.

### 5.5 Variation: Time-of-Arrival Estimates

As described herein, the system executes Blocks of the method S100: to define a set of delay grid values corresponding to candidate propagation delays for a candidate signal transmitted from a candidate device and received at a node; to pre-compute corpuses of conditional probability masses for the candidate device occupying positions in a reference coordinate system based on the set of delay grid values and known positions, in the reference coordinate system, occupied by the set of nodes; to later retrieve subsets of conditional probability masses according to propagation delay values for a localization signal transmitted by a target device and received at the set of nodes; to calculate a composite probability map for the set of nodes based on these subsets of conditional probability masses; and to calculate an estimated position, in the reference coordinate system, occupied by the target device based on the composite probability map.

However, the system can similarly execute Blocks of the method S100: to define a set of time grid values corresponding to candidate time of arrival estimates for a candidate signal transmitted from a candidate device and received at a node; to pre-compute corpuses of conditional probability masses for the candidate device occupying positions in a reference coordinate system based on the set of time grid values and known positions, in the reference coordinate system, occupied by the set of nodes; to later retrieve subsets of conditional probability masses according to time of arrival estimates for a localization signal transmitted by a target device and received at the set of nodes; to calculate a composite probability map for the set of nodes based on these subsets of conditional probability masses; and to calculate an estimated position, in the reference coordinate system, occupied by the target device based on the composite probability map.

### 5.6 Node Retraining

Generally, the system can retrain the set of nodes (or a subset of nodes) in response to modification of the set of nodes (e.g., a new node is added to the set of nodes, a node is moved).

In response to movement or addition of a target node, and in response to absence of change to a bounding area for conditional probability masses associated with other nodes, the system retrains the target node and bypasses retraining of the other nodes (e.g., the conditional probability masses associated with these other nodes remain unchanged).

However, in response to change in the bounding area (e.g., to a new bounding area), the system retrains each node in the set of nodes in order to provide coverage for additional grid points for the new bounding area.

In one implementation, the system repeats the foregoing methods and techniques for a target node in the set of nodes: to calculate a subset of conditional probability masses—for each altitude grid value in the set of altitude grid values and for each delay grid value in the set of delay grid values—in a corpus of conditional probability masses associated with the target node; and to store the corpus of conditional probability masses in the data repository. The subset of conditional probability masses represents probability masses for positions of a target node within a reference coordinate system representing a space based on the delay grid value, the altitude grid value, and an updated position of the target node (e.g., relocation of the first node from the first known location to a second known location) in the space.

### 6. NODE SELECTION AND EXCLUSION

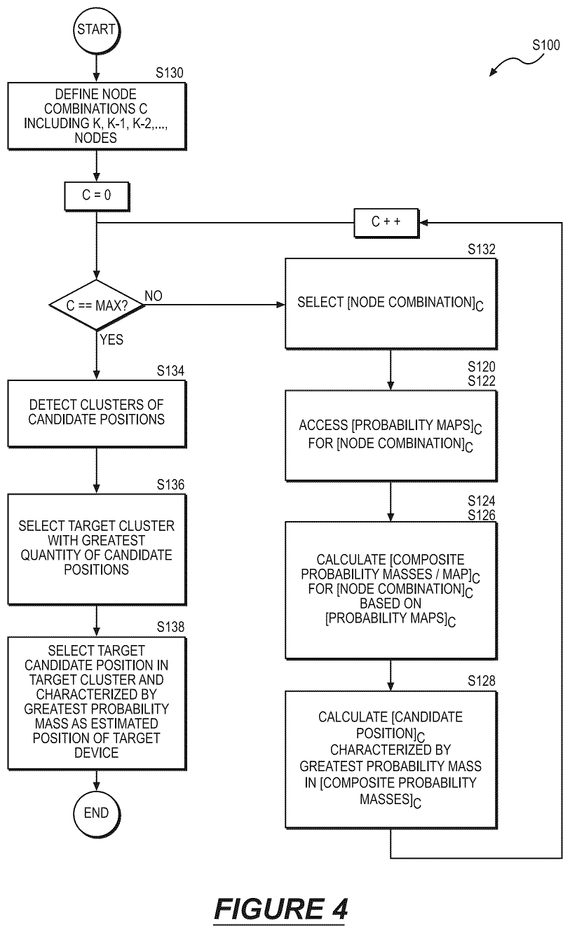

In one variation, as shown in FIG. 4, the remote computer system executes the foregoing methods and techniques for each node in the set of nodes: to access a channel impulse response—characterized by a set of propagation delay values—for a signal transmitted by a target device and received at the node; to calculate (or retrieve) subsets of conditional probability masses for positions of the reference coordinate system based on the set of propagation delay values; to calculate a set of conditional probability masses for the set of positions based on the subsets of propagation delay values; and to generate a probability map representing the set of conditional probability masses.

In this variation, the remote computer system defines a set of combinations of nodes in the set of nodes in Block S130. For each combination of nodes in the set of nodes, the remote computer system executes the foregoing methods and techniques: to access a set of probability maps representing conditional probability masses for the set of positions based on a set of propagation delay values of a channel impulse response for the signal received at the node in Blocks S120 and S122; to calculate a composite set of conditional probability masses for the set of positions based on the set of probability maps in Block S124; to generate a composite probability map for the combination of nodes based on the set of probability map in Block S126; and to calculate a candidate position, in the reference coordinate system, occupied by the target device based on the composite probability map in Block S128. The candidate position is characterized by a conditional probability mass representing a probability mass for the target device occupying the candidate position.

In this variation, the remote computer system: detects clusters of candidate positions in Block S134, each cluster of candidate positions characterized by a quantity of candidate positions; selects a target cluster of candidate positions characterized by a greatest quantity of candidate positions among the clusters of candidate positions in Block S136; and selects a target candidate position—in the target cluster of candidate positions and characterized by the greatest probability mass among candidate positions in the target cluster of candidate positions—as the estimated position occupied by the target device in Block S136.

Accordingly, the system can: calculate candidate positions for the target device based on probability maps for different combinations of nodes; detect clusters of candidate positions in the reference coordinate system; and isolate a target cluster of candidate positions characterized by the greatest quantity of candidate positions in order to discard outlier candidate positions that may be erroneous due to absence of line-of-sight reception of the signal at a node.

Therefore, the remote computer system can select a candidate position—in the target cluster of candidate positions and characterized by the greatest probability mass—as the estimated position occupied by the target device in order to reduce multipath-induced error during position estimation and/or improve accuracy of the estimated position of the target device.

### 6.1 Combinations of Nodes

In this variation, the remote computer system can define a set of combinations of nodes in the set of nodes.

For example, the remote computer system can define the set of combinations of nodes—in the set of nodes including ten nodes—including: a first combination of nodes; a second combination of nodes; a third combination of nodes; a fourth combination of nodes; a fifth combination of nodes; etc.

In this example, the first combination of nodes is characterized by nine nodes in the set of nodes: including the first node and the second node; and excluding a third node. The second combination of nodes is characterized by nine nodes in the set of nodes including: the first node; the second node; and the third node. The third combination of nodes is characterized by nine nodes in the set of nodes: including the second node and the third node; and excluding the first node.

In this example, the fourth combination of nodes is characterized by eight nodes in the set of nodes: including the first node; and excluding the second node and the third node. The fifth combination of nodes is characterized by eight nodes in the set of nodes: including the second node; and excluding the first node and the third node.

### 6.2 First Candidate Position

In this variation, the remote computer system selects the first combination of nodes in the set of nodes in Block S132. For each node in the first combination of nodes, the remote computer system accesses a probability map, in a first set of probability maps, representing conditional probability masses for the set of positions based on a set of propagation delay values of a channel impulse response for the signal received at the node.

The remote computer system then: calculates a first composite set of conditional probability masses for the set of positions based on the first set of probability maps; generates a first composite probability map—for the first combination of nodes—representing the first composite set of conditional probability masses in Block S126; and calculates a first candidate position, in a set of candidate positions, occupied by the target device based on the first composite probability map in Block S128. The first candidate position is characterized by a first conditional probability mass corresponding to the greatest probability mass in the first composite set of conditional probability masses.

### 6.3 Additional Candidate Positions

The remote computer system repeats the foregoing methods and techniques for each combination of nodes in the set of combinations of nodes.

For example, the remote computer system selects the second combination of nodes in the set of nodes. For each node in the second combination of nodes, the remote computer system accesses a probability map, in a second set of probability maps, representing conditional probability masses for the set of positions based on a set of propagation delay values of a channel impulse response for the signal received at the node.

In this example, the remote computer system then: calculates a second composite set of conditional probability masses for the set of positions based on the second set of probability maps; generates a second composite probability map—for the second combination of nodes—representing the second composite set of conditional probability masses; and calculates a second candidate position, in the set of candidate positions, occupied by the target device based on the second composite probability map. The second candidate position is characterized by a second conditional probability mass corresponding to the greatest probability mass in the second composite set of conditional probability masses.

### 6.4 Clusters of Candidate Positions

In this variation, the remote computer system detects a set of clusters of candidate positions in the reference coordinate system in Block S134.

More specifically, for each candidate position in the set of candidate positions, the remote computer system can associate the candidate position with a cluster of candidate positions based on proximity between the candidate position and candidate positions in the cluster of candidate positions (e.g., a distance between the candidate position and a centroid of the cluster of candidate positions falling below a threshold distance).

In one example, the remote computer system associates the first candidate position with a first cluster of candidate positions based on proximity between the first candidate position and candidate positions in the first cluster of candidate positions.

In this example, the remote computer system associates the second candidate position with a second cluster of candidate positions based on proximity between the second candidate position and candidate positions in the second cluster of candidate positions.

### 6.5 Estimated Position Selection

In this variation, the remote computer system calculates a quantity of candidate positions in each cluster of candidate positions in the set of clusters of candidate positions.

For example, the remote computer system can: calculate a first quantity of candidate positions in the first cluster of candidate positions; and calculate a second quantity of candidate positions in the second cluster of candidate positions.

In this example, the remote computer system calculates the second cluster of candidate positions falling below the first quantity of candidate positions.

The remote computer system then: selects a target cluster of candidate positions, in the set of clusters of candidate positions, characterized by the greatest quantity of candidate positions among the clusters of candidate positions in Block S136; and selects a target candidate position—in the target cluster of candidate positions and characterized by the greatest probability mass among candidate positions in the target cluster of candidate positions—as the estimated position occupied by the target device in Block S138.

For example, the remote computer system can: select the first cluster of candidate positions in response to detecting the first quantity of candidate positions corresponding to the greatest quantity of candidate positions among (e.g., the first quantity of candidate positions exceeding the second quantity of candidate positions); and select the first candidate position, in the first cluster of candidate positions, as the estimated position occupied by the target device in response to detecting the first conditional probability mass exceeding conditional probability masses of candidate positions in the first cluster of candidate positions.

Therefore, by isolating the first cluster of candidate positions (e.g., the first cluster of candidate positions associated with the first combination of nodes excluding the third node) characterized by the greatest quantity of candidate positions, the system can discard outlier candidate positions (e.g., the second cluster of candidate positions associated with the second combination of nodes including the third node) that may be erroneous due to absence of line-of-sight reception of the signal at a node (e.g., the third node), thereby reducing multipath-induced error during position estimation and/or improving accuracy of the estimated position of the target device.

### 6.1 Signal-to-Noise Ratio

In another variation, the remote computer system executes the foregoing methods and techniques to access a channel impulse response for the signal transmitted by the target device and received at a target node in the set of nodes. The channel impulse response is characterized by a set of propagation delay values—and a set of amplitude values—for a set of components of the signal.

In this variation, the remote computer system calculates a signal-to-noise ratio for the signal received at the target node based on the set of amplitude values.

In response to detecting the signal-to-noise ratio falling below a threshold signal-to-noise ratio, the remote computer system: selects a subset of nodes, in the set of nodes, excluding the target node; accesses a set of probability maps representing conditional probability masses for the set of positions of the reference coordinate system based on sets of propagation delay values for the signal received at the subset of nodes; calculates a composite set of conditional probability masses based on the set of probability maps; generates a composite probability map—for the subset of nodes—based on the set of probability maps; and calculates an estimated position occupied by the target device based on the composite probability map. The estimated position is characterized by the greatest probability mass in the composite set of conditional probability masses.

For example, the remote computer system can: access a first set of amplitude values of a first channel impulse response for the signal received at the first node in the set of nodes; and calculate a first signal-to-noise ratio for the signal received at the first node based on the first set of amplitude values.

In this example, the remote computer system repeats the foregoing methods and techniques: to calculate a second signal-to-noise ratio for the signal received at the second node based on a second set of amplitude values of a second channel impulse response for the signal received at the second node; and to calculate a third signal-to-noise ratio for the signal received at the third node based on a third set of amplitude values of a third channel impulse response for the signal received at the third node.

In this example, the remote computer system can detect: the first signal-to-noise ratio exceeds the threshold signal-to-noise ratio; the second signal-to-noise ratio exceeds the threshold signal-to-noise ratio; and the third signal-to-noise ratio falling below the threshold signal-to-noise ratio.

In response to detecting the third signal-to-noise ratio for the signal received at the third node falling below the threshold signal-to-noise ratio (and in response to detecting the first signal-to-noise ratio and the second signal-to-noise ratio exceeding the threshold signal-to-noise ratio), the remote computer system can select a subset of nodes: including the first node and the second node; and excluding the third node.

In this example, the remote computer system: accesses a probability map, in a set of probability maps, for each node in the subset of nodes; generates the composite probability map for the subset of nodes representing a composite set of conditional probability masses based on the set of probability maps; and calculates the estimated position, occupied by the target device, characterized by the greatest probability mass in the composite set of conditional probability masses.

Therefore, the system can: detect the third signal-to-noise ratio falling below the threshold signal-to-noise ratio; select the subset of nodes excluding the third node; and calculate the estimated position occupied by the target device based on the composite probability map for the subset of nodes excluding the third node in order to mitigate (potential) error attributed to noisy signal measurements (e.g., propagation delay values) at the third node.

### 7. TIME DIFFERENCE OF ARRIVAL GLOBAL OPTIMIZATION

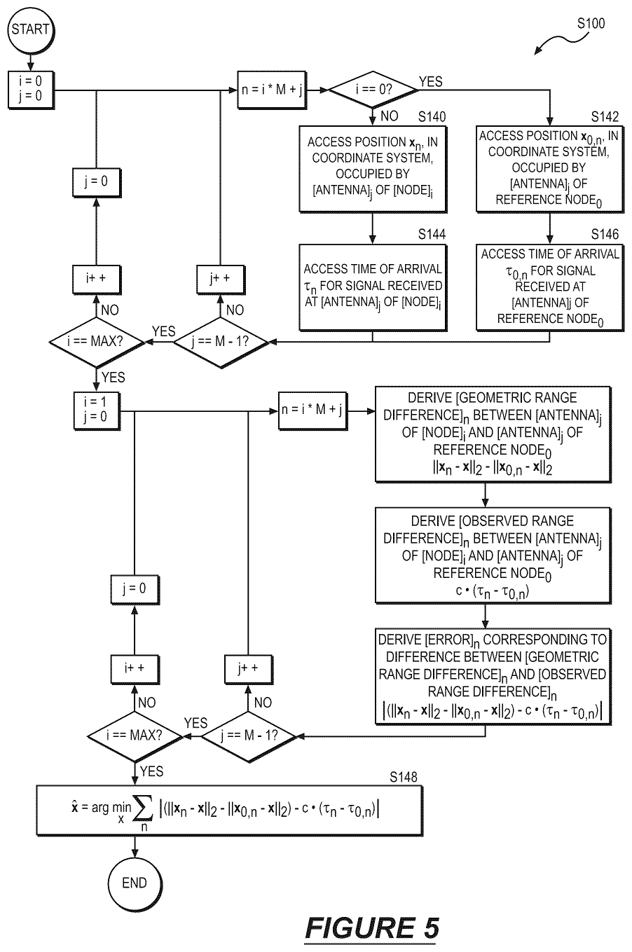

Generally, as shown in FIG. 5, the system can include a set of nodes i=0, . . . , N—including a reference node i=0—arranged in a space. Each node in the set of nodes includes a set of antennas j=0, . . . , M. For example, each antenna can be identified by a linear index n=i·M+j.

In one implementation, in Blocks S140 and S142, the system accesses a position (e.g., a set of coordinates)—in a set of positions of the reference coordinate system—occupied by each antenna for the set of nodes.

For example, the system can: access a target position xₙ, in the set of positions, occupied by a target antenna n of a target node (e.g., an antenna j for node i=1) in the set of nodes in Block S140; and a reference position x_{0,n}, in the set of positions, occupied by a reference antenna of the reference node in Block S142.

The system executes the foregoing methods and techniques to access time-of-arrival estimates for a signal (e.g., a localization signal) transmitted from a target device and received at antennas of the set of nodes.

For example, the system can access: a target time-of-arrival estimate τₙ for the signal received at the target antenna n of the target node in Block S144; and a reference time-of-arrival estimate τ_{0,n} for the signal received at a reference antenna of the reference node (e.g., an antenna j for node i=0) in Block S146.

In another implementation, the system characterizes a first term ∥xₙ−x∥₂ representing a first geometric range (or distance) between the target antenna n and the target device. The first term corresponds to an L2 norm (or a Euclidian norm) of a difference between the target position xₙ and a candidate position x, in the set of positions, occupied by the target device.

In this implementation, the system characterizes a second term ∥x_{0,n}−x∥₂ representing a second geometric distance between the reference antenna and the target device. The second term corresponds to an L2 norm of a difference between the reference position x_{0,n} and the candidate position x occupied by the target device.

The system then characterizes a third term ∥xₙ−x∥₂−∥x_{0,n}−x∥₂ representing a geometric range difference for the reference antenna and the target device. The third term corresponds to a difference between the first geometric range and the second geometric range.

In another implementation, the system characterizes a fourth term c·(τₙ−τ_{0,n}) representing an observed range difference for the target antenna n and the reference antenna. The fourth term corresponds to a product of a wave speed c for the signal and a difference between the target time-of-arrival estimate τₙ and the reference time-of-arrival estimate τ_{0,n}.

In another implementation, the system characterizes a fourth term |(∥xₙ−x∥₂−∥x_{0,n}−x∥₂)−c·(τₙ−τ_{0,n})| representing an error value, in a set of error values, corresponding to a magnitude of a difference between the geometric range difference and the observed range difference for the target antenna n and the reference antenna.

The system can repeat the foregoing methods and techniques for additional pairs of antennas, such as a pair of antennas including a second target antenna—of a second target node in the set of nodes—and the reference antenna of the reference node: to characterize a geometric range difference for a pair of antennas; to characterize an observed range difference for the pair of antennas; and to characterize an error value, in the set of error values, for the pair of antennas based on a difference between the geometric range difference and the observed range difference.

In another implementation, in Block S148, the system can then calculate an estimated position \hat{x}, in the set of positions, occupied by the target device based on an objective function that minimizes a sum of the set of error values, wherein:

$$\hat{x} = arg {min}_{x} {\sum }_{n} \vert ( {‖ {x}_{n} - x ‖}_{2} - {‖ {x}_{0 , n} - x ‖}_{2} ) - c \cdot ( {τ}_{n} - {τ}_{0 , n} ) \vert$$

Accordingly, the system can compute a solution—for the estimated position \hat{x} occupied by the target device—that minimizes the difference between the geometric range difference and the observed range difference for each pair of antennas (e.g., a pair of antennas including a target antenna of a target node and a reference antenna of the reference node) for the set of nodes.

Therefore, by calculating the estimated position occupied by the target device based on the objective function, the system can bypass calculation of probability maps for the set of nodes based on time-of-arrival estimates (or pre-computation of the probability maps based on delay grid values), which may reduce computational cost for calculating the estimated position.

As described herein, the system executes Blocks of the method S100: to define a pair of antennas including a target antenna, characterized by an index j, of a target node (e.g., node i=1) and a reference antenna j—characterized by the same index j—for the reference node (e.g., i=0); and to derive an error value based on a difference between a geometric range difference and an observed range difference for this pair of antennas.

However, the system can similarly execute Blocks of the method S100: to define a pair of antennas including a target antenna, characterized by a first index (e.g., j=0), of a target node (e.g., node i=1) and a reference antenna j—characterized by a second index (e.g., j=1) different from the first index—for the reference node (e.g., i=0); and to derive an error value based on a difference between a geometric range difference and an observed range difference for this pair of antennas; to derive a geometric range difference for the pair of nodes; to derive an observed range difference for the pair of nodes; and to derive an error value based on a difference between a geometric range difference and an observed range difference for this pair of antennas.

### 8. DISCLAIMERS

The systems and methods described herein can be embodied and/or implemented at least in part as a machine configured to receive a computer-readable medium storing computer-readable instructions. The instructions can be executed by computer-executable components integrated with the application, applet, host, server, network, website, communication service, communication interface, hardware/firmware/software elements of a user computer or mobile device, wristband, smartphone, or any suitable combination thereof. Other systems and methods of the embodiment can be embodied and/or implemented at least in part as a machine configured to receive a computer-readable medium storing computer-readable instructions. The instructions can be executed by computer-executable components integrated with apparatuses and networks of the type described above. The computer-readable medium can be stored on any suitable computer readable media such as RAMs, ROMs, flash memory, EEPROMs, optical devices (CD or DVD), hard drives, floppy drives, or any suitable device. The computer-executable component can be a processor, but any suitable dedicated hardware device can (alternatively or additionally) execute the instructions.

As a person skilled in the art will recognize from the previous detailed description and from the figures and claims, modifications and changes can be made to the embodiments of the invention without departing from the scope of this invention as defined in the following claims.

I claim:

1. A method comprising:
accessing a first set of propagation delay values of a first channel impulse response for a localization signal transmitted from a target device and received at a first node in a set of nodes;
accessing a second set of propagation delay values of a second channel impulse response for the localization signal received at a second node in the set of nodes;
generating a first probability map, in a set of probability maps, representing a first set of conditional probability masses for a set of positions in a reference coordinate system, each conditional probability mass in the first set of conditional probability masses representing a probability mass for the target device occupying a position in the set of positions based on the first set of propagation delay values;
generating a second probability map, in the set of probability maps, representing a second set of conditional probability masses for the set of positions, each conditional probability mass in the second set of conditional probability masses representing a probability mass for the target device occupying a position in the set of positions based on the second set of propagation delay values;
generating a composite probability map:
based on the set of probability maps; and
representing a third set of conditional probability masses for the set of positions based on a product of the first set of conditional probability masses and the second set of conditional probability masses; and
calculating an estimated position, in the set of positions, occupied by the target device based on the composite probability map, the estimated position characterized by a greatest probability mass in the third set of conditional probability masses.

2. The method of claim 1, wherein generating the first probability map comprises:
calculating a first subset of conditional probability masses in the first set of conditional probability masses, each conditional probability mass, in the first subset of conditional probability masses, representing a probability mass for the target device occupying a position in the set of positions based on a first propagation delay value in the first set of propagation delay values;
calculating a second subset of conditional probability masses in the first set of conditional probability masses, each conditional probability mass, in the second subset of conditional probability masses, representing a probability mass for the target device occupying a position in the set of positions based on a second propagation delay value in the first set of propagation delay values; and
generating the first probability map representing a sum of subsets of conditional probability masses in the first set of conditional probability masses.

3. The method of claim 1:
wherein accessing the first set of propagation delay values comprises accessing the first set of propagation delay values absent identification of a target propagation delay value, in the first set of propagation delay values, associated with a line-of-sight component in a set of components of the localization signal, the set of components comprising:
the line-of-sight component that is deterministic with respect to position; and
a set of multipath components that are random with respect to position; and
wherein generating the composite probability map comprises:
calculating the third set of conditional probability masses by multiplying sets of conditional probability masses represented by the set of probability maps; and
generating the composite probability map representing the third set of conditional probability masses.

4. The method of claim 1:
further comprising accessing a reference set of propagation delay values of a reference channel impulse response for the localization signal received at a reference node in the set of nodes; and
wherein generating the first probability map comprises:
calculating a first difference between a first propagation delay value, in the first set of propagation delay values, and a second propagation delay value in the reference set of propagation delay values;
calculating a first subset of conditional probability masses in the first set of conditional probability masses, each conditional probability mass, in the first subset of conditional probability masses, representing a probability mass for the target device occupying a position in the set of positions based on the first difference;
calculating a second difference between a third propagation delay value, in the first set of propagation delay values, and the second propagation delay value;
calculating a second subset of conditional probability masses in the first set of conditional probability masses, each conditional probability mass, in the second subset of conditional probability masses, representing a probability mass for the target device occupying a position in the set of positions based on the second difference; and
generating the first probability map representing a sum of subsets of conditional probability masses in the first set of conditional probability masses.

5. The method of claim 4, wherein generating the second probability map comprises:
calculating a third difference between a fourth propagation delay value, in the second set of propagation delay values, and the second propagation delay value in the reference set of propagation delay values;
calculating a third subset of conditional probability masses in the second set of conditional probability masses, each conditional probability mass, in the third subset of conditional probability masses, representing a probability mass for the target device occupying a position in the set of positions based on the third difference; and
generating the second probability map representing a sum of subsets of conditional probability masses in the second set of conditional probability masses.

6. The method of claim 1:
further comprising, during a first time period:
defining a set of delay grid values, each delay grid value, in the set of delay grid values, corresponding to a candidate propagation delay of a candidate signal transmitted from a candidate device and received at a node in the set of nodes;
calculating a first subset of conditional probability masses, each conditional probability mass, in the first subset of conditional probability masses, representing a probability mass for the candidate device occupying a position in the set of positions based on a first delay grid value, in the set of delay grid values, and a first position, in the reference coordinate system, occupied by the first node; and
storing the first subset of conditional probability masses in a data repository; and
wherein generating the first probability map comprises, during a second time period succeeding the first time period:
retrieving the first subset of conditional probability masses from the data repository in response to detecting correspondence between a first propagation delay value, in the first set of propagation delay values, and the first delay grid value; and
generating the first probability map based on the first subset of conditional probability masses.

7. The method of claim 6:
wherein calculating the first subset of conditional probability masses comprises:
for each position in the set of positions, calculating a conditional probability mass, in a group of conditional probability masses, representing a probability mass for the candidate device occupying the position based on the first delay grid value and the first position occupied by the first node; and
selecting the first subset of conditional probability masses in the group of conditional probability masses, each conditional probability mass, in the first subset of conditional probability masses, characterized by a probability mass exceeding a threshold probability mass; and
wherein storing the first subset of conditional probability masses comprises:
storing the first subset of conditional probability masses in the data repository; and
discarding a second subset of conditional probability masses in the group of conditional probability masses, each conditional probability mass, in the second subset of conditional probability masses, characterized by a probability mass falling below the threshold probability mass.

8. The method of claim 1:
further comprising defining a set of altitude grid values, each altitude grid value, in the set of altitude grid values, corresponding to a candidate altitude in the reference coordinate system for the target device;
wherein generating the first probability map comprises generating the first probability map representing the first set of conditional probability masses, each conditional probability mass, in the first set of conditional probability masses, representing a probability mass for the target device occupying a position in the set of positions based on the first set of propagation delay values and a first altitude grid value in the set of altitude grid values; and
wherein generating the second probability map comprises generating the second probability map representing the second set of conditional probability masses, each conditional probability mass, in the second set of conditional probability masses, representing a probability mass for the target device occupying a position in the set of positions based on the second set of propagation delay values and the first altitude grid value.

9. The method of claim 8:
further comprising:
generating a third probability map in a second set of probability maps, the third probability map representing a fourth set of conditional probability masses for the set of positions, each conditional probability mass, in the fourth set of conditional probability masses, representing a probability mass for the target device occupying a position in the set of positions based on the first set of propagation delay values and the second altitude grid value;
generating a fourth probability map in the second set of probability maps, the fourth probability map representing a fifth set of conditional probability masses for the set of positions, each conditional probability mass, in the fifth set of conditional probability masses, representing a probability mass for the target device occupying a position in the set of positions based on the second set of propagation delay values and the second altitude grid value; and
generating a second composite probability map based on the second set of probability maps, the second composite probability map representing a sixth set of conditional probability masses for the set of positions based on a product of the fourth set of conditional probability masses and the fifth set of conditional probability masses; and
wherein calculating the estimated position occupied by the target device comprises calculating the estimated position occupied by the target device based on the composite probability map and the second composite probability map, the estimated position characterized by the greatest probability mass in the third set of conditional probability masses and the sixth set of conditional probability masses.

10. The method of claim 1:
wherein generating the composite probability map comprises:
selecting a first combination of nodes in the set of nodes, the first combination of nodes comprising the first node and the second node;
for each node in the first combination of nodes, accessing a probability map in a first set of probability maps representing conditional probability masses for the set of positions based on a set of propagation delay values of a channel impulse response for the localization signal received at the node; and
generating a first composite probability map for the first combination of nodes based on the first set of probability maps, the first composite probability map representing the third set of conditional probability masses for the set of positions; and
wherein calculating the estimated position occupied by the target device comprises:
calculating a first candidate position, in a first cluster of candidate positions, occupied by the target device based on the first composite probability map, the first candidate position characterized by a first conditional probability mass corresponding to the greatest probability mass in the third set of conditional probability masses; and
selecting the first candidate position as the estimated position occupied by the target device in response to detecting the first conditional probability mass exceeding conditional probability masses of candidate positions in the first cluster of candidate positions.

11. The method of claim 10:
wherein selecting the first combination of nodes comprises selecting the first combination of nodes:
comprising the first node and the second node; and
excluding a third node in the set of nodes;
wherein generating the composite probability map comprises:
selecting a second combination of nodes in the set of nodes, the second combination of nodes comprising the first node, the second node, and the third node;
for each node in the second combination of nodes, accessing a probability map in a second set of probability maps representing conditional probability masses for the set of positions based on a set of propagation delay values of a channel impulse response for the localization signal received at the node; and
generating a second composite probability map for the second combination of nodes based on the second set of probability maps; and
wherein calculating the estimated position occupied by the target device comprises:
calculating the first candidate position in the first cluster of candidate positions, the first cluster of candidate positions characterized by a first quantity of candidate positions;
calculating a second candidate position, in a second cluster of candidate positions, occupied by the target device based on the second composite probability map, the second cluster of candidate positions characterized by a second quantity of candidate positions; and
selecting the first candidate position as the estimated position occupied by the target device in response to:
detecting the first conditional probability mass exceeding conditional probability masses for candidate positions in the first cluster of candidate positions; and
detecting the first quantity of candidate positions exceeding the second quantity of candidate positions.

12. The method of claim 10, wherein calculating the first candidate position comprises:
calculating the first candidate position based on the first composite probability map; and
associating the first candidate position with the first cluster of candidate positions based on proximity between the first candidate position and candidate positions in the first cluster of candidate positions.

13. The method of claim 1, wherein generating the composite probability map comprises:
accessing a set of amplitude values of a third channel impulse response for the localization signal received at a third node in the set of nodes;
calculating a signal-to-noise ratio for the localization signal received at the third node based on the set of amplitude values;
in response to detecting the signal-to-noise ratio for the localization signal received at the third node falling below a threshold signal-to-noise ratio, selecting a first subset of nodes in the set of nodes, the first subset of nodes:
comprising the first node and the second node; and
excluding the third node;
for each node in the first subset of nodes, accessing a probability map in the set of probability maps representing conditional probability masses for the set of positions based on a set of propagation delay values of a channel impulse response for the localization signal received at the node; and
generating the composite probability map for the first subset of nodes based on the set of probability maps.

14. The method of claim 1:
wherein accessing the first set of propagation delay values comprises accessing the first set of propagation delay values of the first channel impulse response for the localization signal received at the first node during a first time period;
wherein accessing the second set of propagation delay values comprises accessing the second set of propagation delay values of the second channel impulse response for the localization signal received at the second node during the first time period;
further comprising:
accessing a third set of propagation delay values of a third channel impulse response for a second localization signal transmitted from the target device and received at the first node during a second time period succeeding the first time period;
generating a third probability map in the set of probability maps, the third probability map representing a fourth set of conditional probability masses for the set of positions, each conditional probability mass, in the fourth set of conditional probability masses, representing a probability mass for the target device occupying a position in the set of positions based on the fourth set of propagation delay values;
accessing a fourth set of propagation delay values of a fourth channel impulse response for the second localization signal received at the second node during the second time period; and
generating a fourth probability map in the set of probability maps, the fourth probability map representing a fifth set of conditional probability masses for the set of positions, each conditional probability mass, in the fifth set of conditional probability masses, representing a probability mass for the target device occupying a position in the set of positions based on the fourth set of propagation delay values; and
wherein generating the composite probability map comprises generating the composite probability map based on the set of probability maps, the composite probability map representing the third set of conditional probability masses for the set of positions based on a product of:
the first set of conditional probability masses;
the second set of conditional probability masses;
the fourth set of conditional probability masses; and
the fifth set of conditional probability masses.

15. The method of claim 1:
wherein accessing the first set of propagation delay values comprises accessing a first set of time-of-arrival estimates for the localization signal received at the first node, the first set of time-of-arrival estimates based on the first set of propagation delay values;
wherein generating the first probability map comprises generating the first probability map representing the first set of conditional probability masses for the set of positions, each conditional probability mass, in the first set of conditional probability masses, representing a probability mass for the target device occupying a position in the set of positions based on the first set of time-of-arrival estimates;
wherein accessing the second set of propagation delay values comprises accessing a second set of time-of-arrival estimates for the localization signal received at the second node, the second set of time-of-arrival estimates based on the second set of propagation delay values; and
wherein generating the second probability map comprises generating the second probability map representing the second set of conditional probability masses for the set of positions, each conditional probability mass, in the second set of conditional probability masses, representing a probability mass for the target device occupying a position in the set of positions based on the second set of time-of-arrival estimates.

16. A method comprising:
during a first time period:
defining a set of delay grid values, each delay grid value in the set of delay grid values corresponding to a candidate propagation delay of a candidate signal:
transmitted from a candidate device; and
received at a node in a set of nodes;
calculating a first subset of conditional probability masses for a first node in the set of nodes, each conditional probability mass in the first subset of conditional probability masses representing a probability mass for the candidate device occupying a position in a set of positions of a reference coordinate system based on:
a first delay grid value in the set of delay grid values; and
a first position, in the reference coordinate system, occupied by the first node; and
calculating a second subset of conditional probability masses for a second node in the set of nodes, each conditional probability mass, in the second subset of conditional probability masses, representing a probability mass for the candidate device occupying a position in the set of positions based on:
a second delay grid value in the set of delay grid values; and
a second position, in the reference coordinate system, occupied by the second node; and
during a second time period succeeding the first time period:
accessing a first set of propagation delay values for a localization signal transmitted from a target device received at the first node;
accessing a second set of propagation delay values for the localization signal received at the second node;
accessing the first subset of conditional probability masses in response to detecting correspondence between:
a first propagation delay value in the first set of propagation delay values; and
the first delay grid value;
accessing the second subset of conditional probability masses in response to detecting correspondence between:
a second propagation delay value in the second set of propagation delay values; and
the second delay grid value;
calculating a composite set of conditional probability masses based on a product of the first subset of conditional probability masses and the second subset of conditional probability masses, each conditional probability mass in the set of conditional probability masses representing a probability mass for the target device occupying a position in the set of positions based on:
the first set of propagation delay values; and
the second set of propagation delay values; and
calculating an estimated position, in the set of positions, occupied by the target device, the estimated position characterized by a greatest probability mass in the composite set of conditional probability masses.

17. The method of claim 16:
further comprising, during the first time period:
calculating a third subset of conditional probability masses for the first node, each conditional probability mass, in the third subset of conditional probability masses, representing a probability mass for the candidate device occupying a position in the set of positions based on a third delay grid value in the set of delay grid values; and
calculating a fourth subset of conditional probability masses for the second node, each conditional probability mass, in the fourth subset of conditional probability masses, representing a probability mass for the candidate device occupying a position in the set of positions based on a fourth delay grid value in the set of delay grid values;
further comprising, during the second time period:
accessing the third subset of conditional probability masses in response to detecting correspondence between a third propagation delay value, in the first set of propagation delay values, and the third delay grid value;
accessing the second subset of conditional probability masses in response to detecting correspondence between a second propagation delay value, in the second set of propagation delay values, and the second delay grid value;
calculating a first set of conditional probability masses for the first node based on a sum of the first subset of conditional probability masses and the third subset of conditional probability masses; and
calculating a second set of conditional probability masses for the second node based on a sum of the second subset of conditional probability masses and the fourth subset of conditional probability masses; and
wherein calculating the composite set of conditional probability masses comprises calculating the composite set of conditional probability masses based on a product of the first set of conditional probability masses and the second set of conditional probability masses.

18. The method of claim 16:
wherein defining the set of time grid values comprises:
defining the set of time grid values; and
defining a set of altitude grid values, each altitude grid value, in the set of altitude grid values, corresponding to a candidate altitude in the reference coordinate system for the candidate device;
wherein calculating the first subset of conditional probability masses comprises calculating the first subset of conditional probability masses representing probability masses for the candidate device occupying positions in the set of positions based on:
the first delay grid value;
a first altitude grid value in the set of altitude grid values; and
the first position occupied by the first node;
further comprising calculating a second composite set of conditional probability masses representing probability masses for the target device occupying positions in the set of positions based on the first set of propagation delay values, the second set of propagation delay values, and a second altitude grid value in the set of grid values; and
wherein calculating the estimated position comprises calculating the estimated position characterized by the greatest probability mass in the composite set of conditional probability masses and the second composite set of conditional probability masses.

19. The method of claim 16:
wherein calculating the first subset of conditional probability masses comprises:
calculating the first subset of conditional probability masses based on the first delay grid value and the first position occupied by the first node; and
storing the first subset of conditional probability masses, in association with the first delay grid value, in a data repository; and
wherein accessing the first subset of conditional probability masses comprises:
identifying the first propagation delay value as corresponding to the first delay grid value; and
retrieving the first subset of conditional probability masses from the data repository according to the first delay grid value corresponding to an index in the data repository.

20. A method comprising:
accessing a first set of time-of-arrival estimates for a localization signal transmitted from a target device and received at a first node;
accessing a second set of time-of-arrival estimates for the localization signal received at a second node;
calculating a first set of conditional probability masses for a set of positions of a reference coordinate system, each conditional probability mass in the first set of conditional probability masses representing a probability mass for the target device occupying a position in the set of positions based on:
the first set of time-of-arrival estimates; and
a first position, in the set of positions, occupied by the first node;
calculating a second set of conditional probability masses for the set of positions, each conditional probability mass in the second set of conditional probability masses representing a probability mass for the target device occupying a position in the set of positions based on:
the second set of time-of-arrival estimates; and
a second position, in the set of positions, occupied by the second node;
calculating a composite set of conditional probability masses for the set of positions based on a product of the first set of conditional probability masses and the second set of conditional probability masses; and
calculating an estimated position, in the set of positions, occupied by the target device based on the composite set of conditional probability masses, the estimated position characterized by a greatest probability mass in the composite set of conditional probability masses.
